(19) United States
(12) Patent Application Publication
(10) Pub. No.: US 2026/0277892 A1
(43) Pub. Date: Sep. 17, 2026

(54) Token-Efficient Sequential Representations of Structured Data

(71) Applicant: GDM Holding LLC, Mountain View, CA (US)

(72) Inventors: Matthew Sharifi, Kilchberg (CH); Florian Nils Hartmann, Zurich (CH)

(21) Appl. No.: 19/080,208

(22) Filed: Mar. 14, 2025

(51) Int. Cl. G06F 16/2453

(52) U.S. Cl. CPC G06F 16/24534

(57) ABSTRACT

An example computer-implemented method includes receiving a query comprising an initial representation of structured data; parsing, based on a syntax of the initial representation of the structured data, at least a portion of the query to identify one or more components of the structured data; reformatting, based on a compression map, the one or more components of the structured data into a compressed-format representation of the portion of the query; tokenizing the compressed-format representation of the portion of the query to obtain a sequence of tokens representing the portion; providing the sequence as input to a machine-learned sequence processing model that computes a plurality of internal activation states, wherein a quantity of the plurality of internal activation states is positively correlated with a length of the sequence; obtaining a response generated using the machine-learned sequence processing model based on the plurality of internal activation states.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In an aspect, the present disclosure provides a first example computer-implemented method. In some implementations, the first example computer-implemented method includes receiving a query comprising an initial representation of structured data. In some implementations, the first example computer-implemented method includes parsing, based on a syntax of the initial representation of the structured data, at least a portion of the query to identify one or more components of the structured data. In some implementations, the first example computer-implemented method includes reformatting, based on a compression map, the one or more components of the structured data into a compressed-format representation of the portion of the query. In some implementations, the first example computer-implemented method includes tokenizing the compressed-format representation of the portion of the query to obtain a sequence of tokens representing the portion. In some implementations, the first example computer-implemented method includes providing the sequence as input to a machine-learned sequence processing model that computes a plurality of internal activation states, wherein a quantity of the plurality of internal activation states is positively correlated with a length of the sequence. In some implementations, the first example computer-implemented method includes obtaining a response generated using the machine-learned sequence processing model based on the plurality of internal activation states.

In some implementations of the first example computer-implemented method, the compression map is configured to reduce a number of tokens in the sequence of tokens representing the portion.

In some implementations of the first example computer-implemented method, reformatting, based on the compression map, the one or more components of the structured data into the compressed-format representation of the portion of the query includes determining, based on the compression map, a control sequence for representing at least one of the one or more components in the compressed-format representation.

In some implementations of the first example computer-implemented method, the compressed-format representation of the portion of the query includes a textual representation.

In some implementations, the first example computer-implemented method includes generating a compressed-format representation of at least a portion of the response. In some implementations, the first example computer-implemented method includes parsing, based on a syntax of the compressed-format representation of at least the portion of the response, the compressed-format representation of at least the portion of the response to identify one or more components of at least the portion of the response. In some implementations, the first example computer-implemented method includes reformatting, based on the compression map, the one or more components of at least the portion of the response into an expanded-format representation of the one or more components of at least the portion of the response.

In some implementations of the first example computer-implemented method, generating the compressed-format representation of at least the portion of the response includes detokenizing the response to generate the compressed-format representation of at least the portion of the response.

In some implementations, the first example computer-implemented method includes replacing an original value in at least the portion of the response with an ad-hoc value to represent the original value in the compressed-format representation of at least the portion of the response.

In some implementations, the first example computer-implemented method includes initializing an embedding vector associated with a token representing the ad-hoc value based on one or more embedding vectors associated with one or more tokens representing the original value.

In some implementations of the first example computer-implemented method, the initial representation of the structured data represents the data in a first structured data language. In some implementations of the first example computer-implemented method, the expanded-format representation of at least the portion of the response represents at least the portion of the response in the first structured data language.

In some implementations of the first example computer-implemented method, the initial representation of the structured data represents the data in a first structured data language. In some implementations of the first example computer-implemented method, the expanded-format representation of at least the portion of the response represents at least the portion of the response in a second structured data language.

In some implementations of the first example computer-implemented method, the expanded-format representation of at least the portion of the response is configured based on an identifier associated with the query.

In some implementations of the first example computer-implemented method, the identifier is associated with one or more preferences, and wherein the expanded-format representation is generated based on the one or more preferences.

In an aspect, the present disclosure provides a second example computer-implemented method. In some implementations, the second example computer-implemented method includes providing query data as an input to a machine-learned sequence processing model. In some implementations, the second example computer-implemented method includes obtaining a response generated using the machine-learned sequence processing model based on the query data, the response indicating a compressed-format representation of at least a portion of the response. In some implementations, the second example computer-implemented method includes parsing, based on a syntax of the compressed-format representation of at least the portion of the response, the compressed-format representation of structured data to identify one or more components of the structured data. In some implementations, the second example computer-implemented method includes reformatting, based on a compression map, the one or more components of the structured data into an expanded-format representation of the one or more components of the structured data. In some implementations, the second example computer-implemented method includes outputting the expanded-format representation of the one or more components of the structured data.

In some implementations, the second example computer-implemented method includes detokenizing the response to generate the compressed-format representation of at least the portion of the response.

In some implementations of the second example computer-implemented method, the response is generated using the machine-learned sequence processing model based on computing, based on a first portion of the response, a plurality of internal activation states, wherein a quantity of the plurality of internal activation states corresponds to a length of the first portion of the response.

In some implementations of the second example computer-implemented method, the response is generated using the machine-learned sequence processing model based on generating, by the machine-learned sequence processing model, and based on the plurality of internal activation states, a second portion of the response.

In some implementations of the second example computer-implemented method, obtaining the response includes autoregressively generating, by the machine-learned sequence processing model, one or more tokens of the response, wherein for each of the one or more tokens of the response, the machine-learned sequence processing model computes a plurality of attention values with respect to one or more other tokens of the response that correspond to the compressed-format representation of at least the portion of the response.

In some implementations, the second example computer-implemented method includes receiving a query comprising an initial representation of structured data. In some implementations, the second example computer-implemented method includes parsing, based on a syntax of the initial representation of the structured data, at least a portion of the query to identify one or more components of the structured data. In some implementations, the second example computer-implemented method includes reformatting, based on the compression map, the one or more components of the structured data into a compressed-format representation of the portion of the query. In some implementations, the second example computer-implemented method includes tokenizing the compressed-format representation of the portion of the query to obtain a sequence of tokens representing the portion. In some implementations, the second example computer-implemented method includes providing the sequence as the input to the machine-learned sequence processing model.

In some implementations of the second example computer-implemented method, generating the compressed-format representation of at least the portion of the response includes detokenizing one or more outputs of the machine-learned sequence processing model to generate the compressed-format representation of the structured data.

In some implementations of the second example computer-implemented method, reformatting, based on the compression map, the one or more components of the structured data into the compressed-format representation of the portion of the query includes determining, based on the compression map, a control sequence for representing at least one of the one or more components in the compressed-format representation.

In an aspect, the present disclosure provides a third example computer-implemented method. In some implementations, the third example computer-implemented method includes receiving a training example comprising an initial representation of structured data. In some implementations, the third example computer-implemented method includes parsing, based on a syntax of the initial representation of the structured data, one or more components of the structured data from the training example. In some implementations, the third example computer-implemented method includes reformatting, based on a compression map, the one or more components of the structured data into a compressed-format representation of the one or more components of the structured data. In some implementations, the third example computer-implemented method includes tokenizing the compressed-format representation of the one or more components of the structured data to obtain a sequence of tokens representing the one or more components of the structured data. In some implementations, the third example computer-implemented method includes training a machine-learned sequence processing model to predict, based on at least a portion of the training example, the sequence of tokens representing the one or more components of the structured data.

In an aspect, the present disclosure provides an example one or more non-transitory computer-readable media storing instructions that are executable by one or more processors to cause a computing system to perform operations, the operations comprising an implementation of the first example computer-implemented method, the second example computer-implemented method, or the third example computer-implemented method, or any combination thereof.

In an aspect, the present disclosure provides an example computing system. In some implementations, the example computing system includes one or more processors. In some implementations, the example computing system includes one or more non-transitory computer-readable media storing instructions that are executable by the one or more processors to cause the computing system to perform operations, the operations comprising an implementation of the first example computer-implemented method, the second example computer-implemented method, or the third example computer-implemented method, or any combination thereof.

In an aspect, the present disclosure provides an example computer program product comprising instructions that are executable by one or more processors to cause a computing system to perform operations, the operations comprising an implementation of the first example computer-implemented method, the second example computer-implemented method, or the third example computer-implemented method, or any combination thereof.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system according to example implementations of aspects of the present disclosure.

FIG. 2 is a flow chart diagram illustrating an example method for training a machine-learned model according to example implementations of aspects of the present disclosure.

FIG. 3 is a block diagram of an example processing flow for using machine-learned model(s) to process input(s) to generate output(s) according to example implementations of aspects of the present disclosure.

FIG. 4 is a block diagram of an example sequence processing model according to example implementations of aspects of the present disclosure.

FIG. 5 is a block diagram of an example technique for populating an example input sequence for processing by a sequence processing model according to example implementations of aspects of the present disclosure.

FIG. 6 is a block diagram of an example model development platform according to example implementations of aspects of the present disclosure.

FIG. 7 is a block diagram of an example training workflow for training a machine-learned model according to example implementations of aspects of the present disclosure.

FIG. 8 is a block diagram of an inference system for operating one or more machine-learned model(s) to perform inference according to example implementations of aspects of the present disclosure.

FIG. 9 is a block diagram of an example networked computing system according to example implementations of aspects of the present disclosure.

FIG. 10 is a block diagram of an example computing device according to example implementations of aspects of the present disclosure.

FIG. 11 is a block diagram of an example computing device according to example implementations of aspects of the present disclosure.

FIG. 12 is a flow chart diagram illustrating an example method for implementing a machine-learned model according to example implementations of aspects of the present disclosure.

FIG. 13 is a flow chart diagram illustrating an example method for implementing a machine-learned model according to example implementations of aspects of the present disclosure.

FIG. 14 is a flow chart diagram illustrating an example method for training a machine-learned model according to example implementations of aspects of the present disclosure.

### DETAILED DESCRIPTION

Example implementations of the present disclosure provide for token-efficient representations of structured data for processing using machine-learned sequence processing models. A machine-learned model system can map an input structured data representation to an intermediate representation prior to tokenization. The intermediate representation can be configured so that, when tokenized (e.g., using a custom tokenizer), the tokenized representation contains fewer tokens than if the original representation had been tokenized directly. This token saving can lead to lower computational cost for communicating the tokenized representation, performing attention or other prediction operations over the tokenized representation, or generating additional content in the tokenized representation space. This tokenized representation can be processed using the machine-learned model system to generate an output, which can be in the intermediate representation space or another output representation (e.g., the original token space). Any intermediate token representations in the output can be resolved into the structured data representation space by reverting the original mapping.

Structured data languages (e.g., JSON, YAML) for data storage and communication often contain concessions to human readability (e.g., whitespace) which cause them to not be maximally token efficient. Compounding the issue are general-purpose natural language tokenizers that may not have been optimized for representing structured data languages in a token-efficient manner. For instance, a general-purpose natural language tokenizer may not be configured to account for repeating sequences present in structured data languages such as JSON, which can consume a significant amount of space in language models. For example, common keys may be repeated as well as conventional delimiters and other syntactical components (e.g., strings such as “},” or “],”) that, under normal natural language datasets used to build natural language tokenizers, might not be observed together with high frequency.

One approach to translate from a formal language, such as JSON or XML, to a more token-efficient intermediary representation involves a two-stage process. First, a parser, which may be specifically designed for the target formal language, can convert the input into a data structure. This structure can represent the data's hierarchical organization and key-value pairs without the syntactic elements (e.g., braces, brackets, colons) and whitespace that inflate token counts. For instance, a JSON object like ′{“x”: 1, “y”: “text”}′ might be represented internally as a structured data object containing the key-value pairs and optionally a designation of the source format. This intermediate representation inherently reduces token count by eliminating unnecessary syntactic elements and whitespace. For instance, the representation can include “structured(format=json, x=1,y=‘text’)”.

As a baseline for the purposes of discussion, some traditional tokenizers might tokenize the original JSON into a sequence of the following tokens: [{″>, <>, <″:>, <1>, <,″>, <y>, <“:”>, <text_1> . . . <text_n>, <″}>], which is eight tokens plus N, where <text_1> . . . <text_n>represents N textual tokens used to represent the textual string value.

In contrast, the intermediate representation generated according to aspects of the present disclosure can be tokenized into a sequence of fewer tokens. For instance, structured(format=json, x=1,y=‘text’)′ may be tokenized as ′[<STARTstructured>, <json>, <x>, <=>, <1>, <y>, <=>, <text_1> . . . <text_n>, <ENDstructured>]′, which is seven tokens plus the N textual tokens. Further reductions can be provided by leveraging a standard vocabulary of key tokens: e.g., <x=>and <y=>, in lieu of the original keys. The sequence then may be tokenized as ′[<STARTstructured>, <json>, <x=>, <1>, <y=>, <text_1> . . . <text_n>, <ENDstructured>]′, which is five tokens plus the N textual tokens. In an example, the <json>token may be used to signal the start of a structured data portion according to the JSON format. A mapping of the original keys (which themselves may be one or multiple tokens) to the standard library can be used to recover the original keys from the placeholders.

The benefits of techniques according to the present disclosure can increase in magnitude with a size of the structured data object. For instance, for a large amount of structured data in which keys or syntactical sequences may be repeated many times, the efficiency of the intermediate representation can be significant. For instance, some keys in the structured data may be multi-token sequences (e.g., “dateCreated”). This multi-token key can be mapped to a single token. For instance, a single token can be selected based on a map to a predefined key token (e.g., “dateCreated”-> “x=”). A single token key can be selected based on a newly defined token embedding composed from the embeddings of each of the tokens of the multi-token key. For instance, a single representative token embedding can be generated by averaging the embedding values of each of the token embeddings of the multi-token key.

In this manner, for instance, a system can format an inputted structured data object using a compression map that maps an initial representation of a structured data object to an intermediate representation that provides a compressed-format representation of the structured data object. A machine-learned sequence processing model can ingest the compressed-format representation and generate an output. The output can be generated directly into the compressed-format representation space (e.g., to provide a continuation of or a new structure data object) and then expanded into the original structured data object space using an expansion map (e.g., from one or more tokens of the compressed-format representation to the original set of key-value pairs of the structured data object). The output can be generated directly into an original representation space, such as to provide a response that does not include a structure (e.g., a JSON object or XML fragment). For instance, the response can be a question answer, a snippet of generated code, an image, or any arbitrary datatype generated by the machine-learned sequence processing model conditioned on the structured data object.

Advantageously, a system can train a model to perform inference in the compressed-format representation space using unsupervised learning. For instance, a language modeling loss may generally train a model to reconstruct a target output based on an input. The reconstruction may be evaluated with respect to source material in a training example if the goal is to reconstruct the source material. For training a model to process compressed-format representations, training examples can be at least partially compressed into the compressed-format representation prior to input to the model to transform the reconstruction task to reconstruct the compressed-format representation. The quality of this reconstruction can be measured with respect to the compressed-format representation (e.g., rather than the original format) so that the model can be trained to perform inference in the compressed-format representation space.

This training can be conducted jointly with training over original format data (e.g., natural language, images, audio, etc.). For example, during training the machine-learned sequence processing model may be provided inputs that contain a compressed-format representation and a second representation that is not the compressed-format representation. For instance, the compressed-format representation can be accompanied by plain text, image data, audio, or any other data modality. For instance, the compressed-format representation can be accompanied by plain text, image data, audio, or any other data modality. For example, tokens corresponding to a compressed-format representation of structured data may be interleaved with tokens corresponding to other data in an input sequence to a model. The machine-learned sequence processing model may generate outputs that contain a compressed-format representation and a second representation that is not the compressed-format representation. For instance, the compressed-format representation can be accompanied by plain text, image data, audio, or any other data modality. For instance, the compressed-format representation can be accompanied by plain text, image data, audio, or any other data modality. A reconstruction loss (or multiple losses) can be applied over the outputs to prepare a model update jointly for the performance over the mixed inputs.

Example implementations of the present disclosure can provide a number of technical effects and benefits. For example, increased token-efficiency of inputs and outputs processed using machine-learned sequence processing models can enable such models to process the same information using fewer computing resources. For example, generating a given quantum of information using fewer tokens can involve fewer decoding steps, which can involve fewer forward passes through the model. In turn, fewer forward passes through the model can involve less processor time for processing a given query, fewer cycles of loading and unloading parameters from memory, etc. Further, fewer decoding steps for a given query can decrease a latency of processing the query.

Further, the computational cost of some machine-learned sequence processing models increases with sequence length. For example, memory consumption can scale with sequence length, as the model execution system may store the input sequence and intermediate activations. Additionally, some model architectures can implement attention over an input sequence. Such attention mechanisms can have an increasing computational cost that scales with the number of tokens in the input sequence. For example, an example model can perform multiple attention computations to obtain an attention score between a position in a sequence and multiple other position in the sequence. Some attention operations scale quadratically with sequence length. By decreasing the number of tokens used to process an input, techniques according to the present disclosure can decrease an amount of computational resources used for performing attention operations. This can reduce the amount of memory and FLOPs required to perform attention. In general, various models may compute internal activation states (e.g., including activation tensors, attention scores, etc.)—and thus a computational cost—in an amount that is positively correlated to sequence length. Therefore, example implementations of the present disclosure, by providing techniques for more token-efficient representations of data, can facilitate a decrease in computational cost for performing inference and training on a given quantum of data.

Additionally, token-efficient representations of model inputs and outputs can lead to improved utilization of storage, memory, and network bandwidth. For example, reduced storage costs can be achieved by storing the tokenized representation of structured data in a database or cache. For example, this can reduce the amount of storage space required for storing model inputs and outputs. Furthermore, reduced memory costs can be achieved by reducing the amount of memory required to load and process model inputs and outputs. For example, smaller tokenized representations can fit into smaller memory buffers, which can improve the efficiency of model training and inference. Finally, reduced communication costs can be achieved by transmitting smaller tokenized representations over a network. For example, smaller representations require less bandwidth, which can reduce the cost of data transfer and improve the speed of communication between different components of a system. Furthermore, a token-efficient representation can enable decreased storage and memory costs for caching and communicating model inputs and outputs.

In this manner, for instance, an example technical effect of example implementations of the present disclosure is increased energy efficiency in performing operations using machine-learned models, thereby improving the functioning of computers implementing such models. For instance, example implementations can provide for more energy-efficient execution of a forward pass (e.g., at runtime or during training). In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.). In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Various example implementations are described herein with respect to the accompanying Figures.

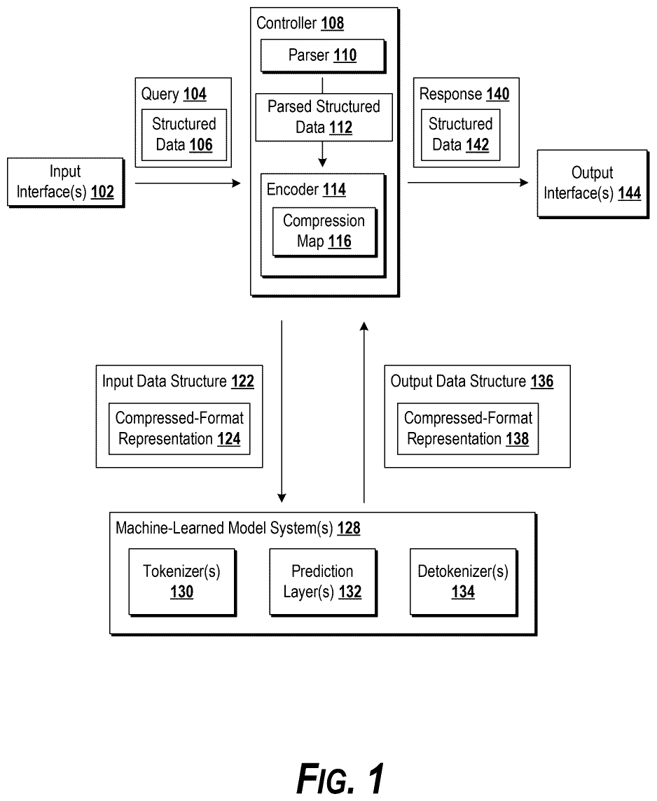

FIG. 1 is a block diagram of an example system for implementing an example machine-learned sequence processing model according to example implementations of the present disclosure. The example system can include one or more input interfaces 102. Input interfaces 102 can receive data descriptive of a query 104. Query 104 can contain or be associated with structured data 106. Controller 108 can receive structured data 106 and process structured data 106 using parser 110. Parser 110 can transform structured data 106 into parsed structured data 112. Encoder 114 can process parsed structured data 112 according to a compression map 116 to compressed data from parsed structured data 112. Controller 108 can provide input data structure 122, containing a compressed-format representation 124 generated by encoder 114, to machine-learned model system(s) 128. Machine-learned model system(s) 128 can ingest input data structure 122 using one or more tokenizer(s) 130. A tokenized representation generated by tokenizer(s) 130 can be processed using one or more prediction layer(s) 132 to generate a prediction output. The prediction output can be detokenized using detokenizer(s) 134 to generate output data for output data structure 136. Based on output data structure 136, which can include further compressed-format representation 138, controller 108 can output response 140, which may include structured data 142 expanded from via one or more output interfaces 144.

Input interfaces 102 can be or include any component capable of accepting a physical or digital input and relaying the input to one or more other components. Input interfaces 102 can include, for instance, at least one of a physical or virtual button (e.g., a graphical user interface field or button), a microphone, a camera, a switch, a keyboard, or a port. Input interfaces 102 can include an application programming interface (API), network address, or other digital interface.

Query 104 can be or include data representing a task to be performed or providing context for performing a task. Query 104 may be expressed in a variety of formats, including but not limited to text (e.g., natural language, structured serialized data representations, computer code), speech, images, or other data modalities.

Query 104 can include explicit instructions or requests. For example, query 104 can be a natural language query such as “Summarize the key findings in this JSON document,” where the JSON document is provided as structured data 106. For instance, query 104 can be a structured query, e.g., a SQL query specifying a database operation to be performed on structured data 106. As another example, query 104 can be a set of programmatic instructions, e.g., a Python script that processes structured data 106. Other example explicit instructions can include questions to be answered, commands to cause machine-learned model system(s) 128 to perform one or more operations, etc.

Query 104 can include implicit instructions or requests. For instance, a model may be configured (e.g., fine-tuned) to perform a particular task based on provided context, such that the inputting of the context can operate as an implicit instruction or request for an output.

For example, a conversational assistant application may receive input context that does not explicitly request assistance (e.g., “my flight is delayed”), and the conversational assistant application may process the input as an implicit query to generate a response to assist the user.

Query 104 can include a combination of explicit instructions and implicit context. For example, a user might provide a natural language description along with a partially completed structured data object, implicitly requesting the system to complete the object based on the query's context.

Query 104 may be associated with metadata that provides additional context about the query itself. This metadata may include information such as a source of the query (e.g., a source application, a user account, a credential or identifier, the time of the query, or other relevant information. This metadata may be used by the system to personalize the response, to track usage patterns, or to improve the system's performance. The presence and use of metadata may vary depending on the specific application and system design. The system may use this metadata to filter or prioritize queries, to adapt a query response to the user's preferences, or to identify potential errors or anomalies in the query.

Structured data 106 can be associated with a query 104. Structured data 106 can be communicated in a message or data file or stream communicating query 104. Query 104 can include structured data 106.

Structured data 106 may be or include a representation of data organized in a structured format. A structured format can include a structured data representation language, such as JSON, XML, or YAML. A structured data representation language can be a language associated with a defined syntax having control sequences that control the interpretation of data or functional sequences. For example, one or more control sequences can provide a structure within which attribute names (e.g., “keys”) and attribute values (e.g., “values”) are defined. For instance, a control sequence between a first data sequence and a second data sequence (e.g., an equals sign between a variable and a numeral, a colon between a key and a value) can assign a value of one data sequence to be assigned with the other data sequence. Other example control sequences can include braces, brackets, tabs, commas, etc. An example structured data representation language includes a programming language that represents functional sequences (e.g., commands to be performed) and data sequences (e.g., variables) according to a defined syntax. A specific schema and content of structured data 106 may vary widely depending on the application and the nature of the query 104.

Structured data 106 can be associated with a parser. For instance, parsing of structured data representation languages like JSON, XML, and YAML can involve analyzing an input string according to the language's syntax rules to create an in-memory structured representation, such as a tree-like structure. For example, JSON parsing can use a recursive descent parser or a stack-based parser to traverse the string, identifying key-value pairs enclosed in curly braces { } for objects and comma-separated values in square brackets [ ] for arrays. XML parsing can use an event-driven parser (like SAX) or a DOM (Document Object Model) parser to build a tree representation of the XML document, handling tags, attributes, and their hierarchical relationships. YAML parsing can use a similar recursive descent approach, interpreting indentation and other control sequences (like colons and hyphens) to determine the structure, handling nested structures and data types such as scalars, sequences, and mappings. Each parser uses the specific syntax rules of its target language to correctly interpret the input and build a meaningful data structure in memory.

Structured data 106 may be embedded within query 104. It may be directly included as part of the query's text. For example, a natural language query string can contain a substring containing a textual structured data representation.

Structured data 106 may be associated with query 104 as a separate data structure. For example, structured data 106 may be referenced by an identifier within the query text. The structured data 106 may also be implicitly represented in query 104, requiring the system to infer its structure and content from the query's context or other associated information.

Controller 108 can be or include processing logic, software, firmware, or hardware configured to control in puts to and process outputs of a machine-learned model of machine-learned model system(s) 128. For example, controller 108 can orchestrate the interaction between various components, including parser 110, encoder 114, and machine-learned model system(s) 128. This orchestration can involve routing data between these components, managing the execution sequence of the components, and handling data transformations to parse an output of one component into a compatible format for input to another component (e.g., populating API calls and parsing API responses).

Parser 110 can be or include processing logic, software, firmware, or hardware configured to process query 104 to obtain or extract structured data 106 and transform structured data 106 into parsed structured data 112. Parser 110 can include a string-based parser that traverses an input string or multiple input strings to identify control sequences in the input that are associated with a structured data representation language (e.g., defined in a syntax or grammar of the language). Parser 110 may be implemented as a recursive descent parser. Parser 110 may implement a context-free grammar specifically designed for a structured data language (e.g., JSON, XML, YAML). This grammar may define the hierarchical structure and key-value relationships within the data. The parser may traverse the input structured data 106 according to the grammar's rules, creating a corresponding Abstract Syntax Tree (AST) or another hierarchical data structure. This AST may represent the data's essential components without the syntactic elements (e.g., braces, brackets, colons) and whitespace.

Parser 110 may be designed to support multiple structured data formats. The parser may be configured to automatically detect the format of the input structured data 106 (e.g., by examining the initial characters or other identifying features) and select the appropriate parsing strategy.

Parsed structured data 112 be or include a data structure representing the contents of structured data 106. For example, parser 110 may process query 104 to identify and extract structured data 106. Parsed structured data 112 may have the same format as structured data 106. Parsed structured data 112 may have a different or proprietary format. Parsed structured data 112 can be or include an in-memory representation of structured data 106. This representation may be a tree-like structure, a graph, or a flat list of key-value pairs, depending on the parser's implementation and the type of structured data being processed.

Encoder 114 can be or include processing logic, software, firmware, or hardware configured to process parsed structured data 112 according to compression map 116 to generate a compressed-format representation 124 of parsed structured data 112.

Encoder 114 can be implemented as a mapping function that transforms a parsed data structure (e.g., parsed structured data 112) into a more token-efficient representation (e.g., compressed-format representation 124). This transformation can leverage a predefined compression map (e.g., compression map 116) to generate a representation that is more token-efficient (e.g., can be represented in fewer tokens).

Encoder 114 can operate by traversing parsed data structure 112. For each element in parsed data structure 112, encoder 114 can consult compression map 116 to determine a corresponding token or a sequence of tokens in a compressed representation. This mapping can be based on various strategies, such as replacing frequently occurring keys with shorter, predefined tokens or using a learned embedding to represent the key-value pairs.

In some implementations, encoder 114 can use predefined tokens to substitute for longer, repeated keys in structured data. This substitution can improve token efficiency and reduce the computational cost of processing the data. For example, consider a structured data object with multiple instances of the key “dateCreated.” Instead of tokenizing the full string “dateCreated” each time it appears, encoder 114 can substitute it with a single predefined token, such as “x=.” A mapping can then associate “x=” with “dateCreated,” allowing for the original key to be recovered if needed.

Several strategies can be used to implement token substitution within encoder 114. One approach involves allocating a set of available placeholder tokens. For example, encoder 114 can reserve a range of tokens, such as “x=”, “y=”, “z=”, etc., to represent frequently occurring keys. Long key names can be assigned to substitute for one of the reserved tokens, such that compressed-format representation 124 can be generated to contain the shorter replacement token in lieu of the longer original key name. For instance, during encoding, when a key is encountered, encoder 114 may check if it has a corresponding placeholder token. If so, the key is replaced with the token. If not, the original value may be passed through.

In some implementations, a tabular mapping can be used for input to a downstream model. This allows the model itself to have visibility into the substitution assignment. For example, encoder 114 can create a table that maps the predefined tokens to their corresponding keys. This table can then be provided as input to the downstream model. The model can be trained to recognize the tokens and treat them as equivalent to their corresponding keys. For example, a model input can include placeholder tokens inserted in place of the longer keys. The longer keys can appear once in the tabular mapping in the input. After one or more cycles of an attention operation over the entire input, the model can encode, into a contextualized representation of the placeholder token, the relationship between that placeholder token and the longer original value. In this manner, for instance, the information bound up in the value name (e.g., descriptive key values or function names) can be propagated via an attention mechanism of the model throughout the input sequence (and output sequence). In this manner, for instance, the model can perform reasoning steps (e.g., generated content containing analysis of inputs to prepare for later generation of output content) or may generate outputs using the shorter key equivalents while maintaining the context of the original association with the full values.

Encoder 114 can incorporate strategies to handle hierarchical structures within parsed data structure 112. For nested structures, encoder 114 can recursively apply compression map 116, ensuring that the compressed representation accurately reflects the hierarchical relationships between the elements. This recursive approach can involve the use of special tokens to mark boundaries of nested structures, ensuring that the tokenizer can correctly interpret the compressed representation. The choice of tokens used to mark nested structures can be designed to minimize token count and avoid conflicts with other tokens in the vocabulary.

Compression map 116 can define mappings between elements of an original grammar of parsed structured data 112 and corresponding sequences in the compressed-format representation 124. Compression map 116 can be or include a lookup table or a set of rules that maps elements from a parsed structured data representation to a compressed tokenized representation. Compression map 116 can include explicitly defined mappings for specific data elements. Compression map 116 can define rules for mapping data elements.

In general, compression map 116 can define a transform from parsed structured data 112 to compressed-format representation 124. Encoder 114 can access different compression map definitions for different types of parsed structured data 112. For example, a first parsed structured data instance may be a parsed structured data instance of JSON data. A second parsed structured data instance may be a parsed structured data instance of Python code. The mapping from JSON data to a compressed-format representation may differ from the mapping of Python code to the same or a different compressed-format representation. For example, encoder 114 can receive one or multiple parsed structured data inputs. For each of the one or multiple parsed structured data inputs, encoder 114 can access a corresponding compression map to perform compression on the parsed structured data input.

Compression map 116 can define global mappings that map control sequences of parsed structured data 112 (e.g., as defined in a syntax or grammar) to more token-efficient schemas of implementing the same control (e.g., with or without implementing the control sequence). For example, some control sequences may not be necessary in a compressed-format representation and may be omitted, which is a more token-efficient manner of implementing the control.

Compression map 116 can define global mappings that map control sequences of parsed structured data 112 to more token-efficient schemas of implementing the same control. For example, common strings expected to be present in structured data (e.g., common function names in popular libraries, datatype labels, etc.) can be mapped to shorter representations thereof, such as single-token representations thereof.

Similarly, some global mapping rules can replace one syntactical schema with another more token-efficient syntactical schema. For instance, in lieu of using tab or space characters at the beginning of every indented line in a YAML file, a global mapping rule can instead strip the whitespace characters and designate indented data lines in a different manner (e.g., enclosed between start and end sequences, such as brackets) Compression map 116 can define local mappings that are specific to a particular instance of structured data 106. For example, local mappings can include relationships between original values (e.g., strings, such as key names) and shorter replacements (e.g., single-token values).

One or more features of a compression map 116 can be implemented as a dictionary, a lookup table, or any other suitable data structure. For example, a dictionary can map keys of parsed structured data 112 to predefined tokens. For instance, the key “dateCreated” can be mapped to the token “x,” and the key “customerID” can be mapped to the token “y.” Compression map 116 can include executable methods that can operate on structured data 106 or mapping tables associated therewith to perform substitutions. Compression map 116 can maintain a table or other representation of which replacement keys are used for which original keys. For example, such a table could include a key-value data structure (e.g., a dictionary) in which the keys are the original keys and the values are the new keys, such that the table can be indexed with the key value while encoding the parsed structured data representation 112 to return the shorter substitution. The table can be inverted for decoding from the compressed representation to retrieve the original values based on indexing into the inverted table using a shorter key value detected in a compressed representation. The table can be provided in the input to a machine-learned model to supply additional context associated with the shorter substitute tokens.

Aspects of compression map 116 can be pre-defined. For example, a set of common keys used in a particular structured data language can be identified, and a corresponding set of tokens can be assigned to these keys. This pre-defined map can be stored as a configuration file or embedded within encoder 114. For instance, common keys such as “id,” “name,” and “value” can be mapped to specific tokens.

Aspects of compression map 116 can be learned. For example, frequently occurring keys in a dataset of parsed structured data 112 can be identified. A mapping between these keys and a set of tokens can be generated based on an objective, such as a token count objective (e.g., minimizing a token count of a tokenized representation).

Aspects of compression map 116 can be static or dynamic. A static map remains unchanged during the encoding process. A dynamic map can be updated during the encoding process. For example, if a new key is encountered that is not in the map, the map can be updated to include a mapping for the new key. For instance, if a data stream includes new customer IDs, compression map 116 can dynamically assign new tokens to these IDs.

Compression map 116 can apply a variable-length encoding scheme, where frequently occurring elements are represented by shorter token sequences, and less frequent elements are represented by longer sequences. For instance, common values in a structured data object might be mapped to single tokens, while less common values might be represented by longer sequences of tokens or by a combination of a token and a string value. This approach can improve compression efficiency by reducing the overall number of tokens needed to represent the data. The frequency of particular tokens may be domain-specific; a vocabulary optimized for medical records may differ from one optimized for sensor data readouts.

Input data structure 122 may be output by controller 108 to cause machine-learned model system(s) 128 to perform processing for query 104. For example, input data structure 122 can contain or otherwise communicate compressed-format representation 124.

Input data structure 122 may be implemented as a data structure configured for processing by a machine-learned sequence processing model. Input data structure 122 can conform to a defined application programming interface that facilitates communication between controller 108 and machine-learned model system(s) 128. Input data structure 122 can include a message or communication that may be transmitted via a network connection to machine-learned model system(s) 128. Input data structure 122 can include assignment of a value to a variable passed as input to a method call or other execution of a function that invokes machine-learned model system(s) 128 to perform inference in the input.

Input data structure 122 can include compressed-format representation 124. Input data structure 122 can include other input data, such as data that has not been compressed by encoder 114. For instance, data from query 104 can be passed in input data structure 122. For example, in addition to compressed-format representation 124, input data structure 122 can include natural language text, image data (e.g., pixel or vector data), audio data, etc.

Compressed-format representation 124 can be or include a representation of data from structured data 106 that, when tokenized by tokenizer(s) 130, is expected to result in a lower quantity of tokens as compared to the original structured data 106 being tokenized by a general-purpose tokenizer. For example, a general-purpose natural language tokenizer may parse JSON content using tokenization rules that were selected for representing a broad domain of content, primarily natural language.

In an example, compressed-format representation 124 can be associated with a custom tokenizer. For example, a syntax of compressed-format representation 124 can be jointly optimized with a dedicated tokenizer to obtain a token-efficient representation of information (e.g., a maximally token-efficient representation over an expected distribution of input data).

In an example, compressed-format representation 124 may be optimized to be more token-efficient with a fixed tokenizer. For instance, a machine-learned sequence processing model may be trained to use a particular token vocabulary. Some models may perform best with its original token vocabulary, such that changing the vocabulary to adapt to a particular domain may introduce some performance regressions. Further, changing the vocabulary and re-training the model may be costly or introduce regressions on performance in other domains. For example, compressed-format representation 124 may be configured to use a given vocabulary of tokens to more efficiently represent structured data. For example, compressed-format representation 124 may be characterized by a grammar that decreases a token sequence length of control sequences (e.g., value assignment operators, hierarchical structure boundaries, function calls, etc.) as generated by a given tokenizer.

Compressed-format representations 124 may provide a canonical representation of data from structured data 106. For example, a canonical representation can provide a standard format for representing data independent from an original source format.

Compressed-format representations 124 can be particularly adapted for different types of structured data. For example, different intermediate structural representations may be used for different source data. For example, tabular data representations may be parsed into an intermediate representation adapted to represent tabular data in a token-efficient manner. Multi-modal datasets may be parsed into an intermediate representation adapted to represent multimodal data in a token-efficient manner. In general, compressed-format representations 124 may be adapted based on a token efficiency objective to increase a token efficiency of representing instances of an input domain of datatypes. A single canonical compressed-format representation 124 schema can be adapted to represent a broad domain of datatypes. More granularly adapted compressed-format representations 124 schemas may be adapted to represent more specific domains by evaluating the token efficiency objective in an optimization routine executed over the narrower domain.

Machine-learned model system(s) 128 can be or include processing logic, software, firmware, or hardware configured to host and execute machine-learned models to obtain predictions. For example, machine-learned model system(s) 128 can include software platforms configured to manage the storage and execution of various different machine-learned models, various different adapters or other profiles for one or more machine-learned models, etc. Machine-learned model system(s) 128 can be implemented locally to a computing system implementing controller 108 (e.g., on a same device or system) or remotely from a computing system implementing controller 108 (e.g., on a different device or system). Machine-learned model system(s) 128 can load machine-learned parameters from storage into memory devices (e.g., memory of one or more hardware accelerator devices), transform inputs based on an architecture of the loaded machine-learned model, maintain a cache of intermediate states (e.g., latent or otherwise) for the machine-learned model during execution, and return outputs generated by the executed model. Machine-learned model system(s) 128 can execute, for instance, one or more machine-learned model(s) 1. Example machine-learned model types and configurations that can be used to process input data structure 122 are described herein with respect to machine-learned model 1. Example aspects of machine-learned model system(s) 128 are described herein with respect to model host 31.

Machine-learned model system(s) 128 can facilitate interactions between components of controller 108 and one or more machine-learned models. Machine-learned model system(s) 128 can directly execute one or more machine-learned models or can provide API access to other systems (on-device or on external devices) that execute one or more machine-learned models using inputs provided via the API.

Machine-learned model system(s) 128 can provide access to generalist models. For instance, machine-learned model systems 128 can provide access to foundational models that are configured to perform inference for a wide variety of tasks. Machine-learned model systems 128 can provide access to machine-learned sequence processing models, such as large language models or “LLMs” or small language models or “SLMs,” vision-language models of “VLMs,” vision models (e.g., convolutional neural nets), audio models, etc.

Machine-learned model systems 128 can provide access to a variety of specialized models that implement various functionality of components of a system (e.g., an agent system, an assistant system, or other software). The models can be designed and trained (e.g., fine-tuned) to perform specific tasks such as parsing and analyzing input data, extracting information to remember, predicting a classification or type of information, extracting memories relevant to a query, etc.

Machine-learned model systems 128 can include or invoke various types of hardware and software components specifically designed to execute machine learning algorithms and models. Examples of devices or systems that can be used to implement machine-learned model systems 128 include dedicated machine learning engines equipped with one or more high-performance GPUs or other hardware accelerators for accelerated computing. These environments can be hosted locally on an edge device or hosted on a server to offload computational tasks.

Tokenizer(s) 130 can include one or more tokenizers configured to process compressed-format representation 124 to generate a tokenized representation for input to prediction layer(s) 132. In some implementations, tokenizer(s) 130 can use a vocabulary to map elements of compressed-format representation 124 to tokens. For example, tokenizer(s) 130 can map a numeric value to a token representing that value. String values can be handled using word tokenization, subword tokenization, character tokenization, byte-level tokenization, etc. Boolean values can be mapped to single tokens representing “true” or “false”. Arrays and nested structures can include tokenized representation of structure, as by using start (or end, or both) tokens to delimit these structures within the tokenized representation.

In some implementations, tokenizer(s) 130 can be configured to handle different data types present in compressed-format representation 124. For example, images can be tokenized using an image tokenizer, textual data can be tokenized using a text tokenizer, audio data can be tokenized using an audio tokenizer, etc. In an example, different tokens can be used to represent the same data in different datatypes. For example, a string “True” and a Boolean value of True may map to the same token if both are treated as text. For example, a tokenized representation of a string “True” may include multiple tokens: a token representing the word true and one or more tokens representing the quotation marks (which may be represented jointly with other characters, such as an assignment character <=″>or a structural delimiter <″}>). In an example, different tokens may be used to represent different datatypes. For instance, the Boolean True may be mapped to a different token than the word in the string “True” such that a single token can communicate both the content and datatype.

In an example, tokenizer(s) 130 can be customized for processing structured languages. For example, some structured languages, e.g., HTML, contain some keys that appear very commonly, e.g. <div>s. Tokenizer 130 can represent such common sequences using a single token. This token can be added to model training (e.g., pretraining or during fine-tuning).

A tokenized representation can include a sequence of tokens representing compressed-format representation 124. For example, the sequence can be an array of tokens, where each token (or a group of tokens) represents a specific element or attribute from compressed-format representation 124. In an example, compressed-format representation 124 is passed to tokenizer(s) 130 as a string, and tokenizer(s) 130 can perform word, subword, character, or byte-level tokenization (or other tokenization schemes) to generate sequences of tokens that represent compressed-format representation 124.

In some implementations, the tokens can correspond to integers, representing indexed values of a vocabulary of predefined tokens. Tokens can be associated with learned embeddings of the corresponding elements represented by the tokens.

In some implementations, compressed-format representation 124 can include metadata alongside the token sequence. This metadata can provide additional information about the original structured data, such as its format (e.g., JSON, XML, YAML), schema, or other relevant attributes. For example, the metadata can include an identifier indicating the type of structured data being represented, or it can include information about the compression scheme used to generate the compressed-format representation.

In some implementations, this metadata can be encoded as a separate token sequence accompanying a main token sequence. In other implementations, the metadata can be embedded within the main token sequence using special tokens or delimiters (e.g., a designated token assigned to represent a format type or other metadata value). The format of the metadata can be designed to ensure that the machine-learned model can easily access and interpret the information. For instance, the metadata can be encoded using a simple key-value pair format, where each key represents a metadata attribute, and each value represents the corresponding attribute value.

In some implementations, compressed-format representation 124 can include special tokens to mark the beginning and end of nested structures within the original structured data. For example, in a JSON object containing nested objects or arrays, control tokens can be used to delineate one or more boundaries of each nested structure. These control tokens can help the tokenizer and the machine-learned model correctly interpret the hierarchical structure of the data. For instance, a control token can be used to mark the beginning of a JSON object, another control token can be used to mark the end of a JSON object, and similar control tokens can be used to mark the beginning and end of JSON arrays.

In some implementations, compressed-format representation 124 can be designed to be easily reversible to the original structured data format. This reversibility can be achieved by using an invertible compression map and by including sufficient metadata to allow for accurate reconstruction of the original data. For example, the compressed-format representation can include or be associated with information about the original data types and the hierarchical structure of the data. This information can be used to reconstruct the original data structure from the compressed representation. In some implementations, the reversibility can be ensured by using a deterministic encoding scheme, where the same input always produces the same compressed-format representation. In other implementations, the reversibility can be achieved by using a probabilistic encoding scheme, where the compressed-format representation might vary slightly for the same input, but the original data can still be accurately reconstructed. The choice of encoding scheme can depend on factors such as the desired level of compression, the computational resources available, and the specific requirements of the application.

In some implementations, custom tokenizer(s) 130 can be trained end-to-end with a machine-learned model to learn a token-efficient representation of structured data that balances concision (e.g., low token count) with contextual signal strength (e.g., ability of the model to maintain performance over context data). For instance, in some instances, for a fixed embedding dimension, increasing a total number of values that map to a single token can decrease a precision of representation of each value. For example, a joint training objective can be to penalize both token count (thereby causing the tokenizer to prefer coarser tokenization resulting in fewer tokens) and prediction errors (thereby helping avoid performance collapse by overgeneralization of token vocabulary.

In an example, aspects of compression can be performed after tokenization. For example, keys that are tokenized into multiple tokens may be represented with a single placeholder token having an embedding initialized from the multiple tokens (e.g., an average value of the token embeddings, a nonlinear or linear combination of the values of the token embeddings). For example, if there is a repeated key number of x per year which is tokenized into [<number_>, <of_>, <x_>, <per_>, <year>], then a representative token can be generated by looking up the embeddings for all of these five token, and assigning the average embedding value (or other aggregation thereof) to an ad hoc token for the entire key number_of_x_per_year. Since this process reduces the number of tokens, this adjustment may be accounted for when assigning positional embeddings. A mapping of the original key to the ad hoc token key can be stored in compression map 116.

In some implementations, the ad hoc token embedding may be predicted using an embedding model configured to output a representative embedding for the input key value. For instance, if there is a repeated key number_of_x_per_year which is tokenized into [<number>, <_>, <of>, <_>, <x>, <_>, <per>, <_>, <year>], it may be found that some tokens provide less information to the overall meaning bound up in the set of tokens. As such a representative embedding for the string “number_of_x_per_year” may be generated using a text embedding model having an output dimension matching the token embedding dimension of prediction layer(s) 132.

Some prediction layer(s) 132 may predict an embedding which is then matched to the closest embedding of a token in an output vocabulary for predicting a next token. In such a system, the ad hoc token embeddings may be added to the lookup index so that, when decoding next tokens from the model, the prediction layer(s) can match a predicted embedding to the ad hoc token embedding, such that the ad hoc token embedding is expected to be the next token in a sequence of tokens.

Some prediction layer(s) 132 may predict a distribution of values over an available output vocabulary. Directly modifying the output vocabulary may be performed when appropriate to include ad hoc tokens. In some architectures, this may require re-training an output head of the prediction layer(s). To avoid such retraining, an in-context look-up table can be used (as described above) to associate the original key value to the new reduced-token representation thereof. The prediction layers 132 can attend over the in-context look-up table to contextualize the token embedding associated with the reduced-token representation and increase a likelihood of the prediction layers predicting the reduced-token representation in lieu of the original key value when that value is next in a predicted sequence. In an example, the initial embedding provided to an input prediction layer can be initialized based on a linear or nonlinear combination of the constituent tokens of the original key value as described above to nudge the association between the original key value and the placeholder token. For example, the initialized token value can be set by an artificial “one-hot attention” operation in which the base placeholder token embedding is updated based on a weighted combination of the base placeholder token embedding and a linear or nonlinear combination of the constituent tokens of the original key value.

Prediction layer(s) 132 can be one or more internal components of a machine-learned model that process an input token sequence and generate predicted values based thereon. For instance, a prediction layer can receive a tensor of vector embeddings that respectively correspond to a list of token identifiers. The prediction layer can process the tensor (e.g., applying one or more linear or nonlinear transforms) to generate a predicted value. The predicted value can be used to obtain a predicted output token. For example, the predicted value can be a logit value that can be normalized over an output vocabulary to identify a predicted next token in a sequence.

Detokenizer(s) 134 can receive a sequence of output tokens predicted by the prediction layers to assemble an output for returning to controller 108. For example, detokenizer(s) 134 can receive a list of token identifiers, map the token identifiers to an underlying data representation (e.g., a string, an image patch, a portion of audio, etc.), and stitch together an output that is not separated into individual tokens. Some prediction outputs may not be detokenized. For instance, an image output that is generated in whole (e.g., and not autoregressively generated token-by-token) may not be detokenized if it is output in a complete, non-tokenized representation.

A custom detokenizer 134 can be provided by inverting a custom tokenizer (e.g., as described above).

Output data structure 136 be or can include a prediction generated based on input data structure 122. Output data structure 136 may include a prediction generated in compressed-format representation 138. Output data structure 136 may not include a prediction generated in compressed-format representation 138.

Output data structure 136 may be output by machine-learned model system(s) 128 in service of performing processing for query 104. For example, output data structure 136 can contain or otherwise communicate compressed-format representation 138.

Output data structure 136 may be implemented as a data structure configured for output by a machine-learned sequence processing model. Output data structure 136 can conform to a defined application programming interface that facilitates communication between controller 108 and machine-learned model system(s) 128. Output data structure 136 can include a message or communication that may be transmitted via a network connection from machine-learned model system(s) 128. Output data structure 136 can include a data stream or returned object from a service, routine, or other executing component.

Output data structure 136 can include compressed-format representation 138. Output data structure 136 can include other input data, such as data that has not been compressed by encoder 114. For instance, machine-learned model system(s) 128 can generate content that is not to be returned in a structured data format (e.g., natural language content, generated image content). For example, in addition to compressed-format representation 138, output data structure 136 can include natural language text, image data (e.g., pixel or vector data), audio data, etc. generated by a model of machine-learned model system(s).

Output data structure 136 can be or include a data object output by machine-learned model system(s) 128. Output data structure 136 can include a structure defined based on an application programming interface of machine-learned model system(s) 128.

Output data structure 136 can contain a single data modality or multiple data modalities. Various example data modalities for output data structure 136 are described herein with respect to the description of outputs from example machine-learned model 1. Output data structure 136 can be or include any one or more of text or other symbolic data, image data, audio data, compressed or encoded data, etc.

Output data structure 136 can include content generated by one or more machine-learned models executed by machine-learned model system(s) 128. Output data structure 136 can include metadata associated with the generated content, such as confidence values, scores (e.g., based on an evaluation policy), logits, etc.

Compressed-format representation 138 can be or include a representation of data from structured data 106 that, when tokenized by tokenizer(s) 130, is expected to result in a lower quantity of tokens as compared to the format of original structured data 106 being tokenized by a general-purpose tokenizer.

In an example, compressed-format representation 138 can be associated with a custom tokenizer. For example, a syntax of compressed-format representation 138 can be jointly optimized with a dedicated tokenizer to obtain a token-efficient representation of information (e.g., a maximally token-efficient representation over an expected distribution of input data).

In an example, compressed-format representation 138 may be optimized to be more token-efficient with a fixed tokenizer. For instance, a machine-learned sequence processing model may be trained to use a particular token vocabulary. The model may perform best with its original token vocabulary, such that changing the vocabulary to adapt to a particular domain may introduce some performance regressions. Further, changing the vocabulary and re-training the model may be costly or introduce regressions on performance in other domains. For example, compressed-format representation 138 may be configured to use a given vocabulary of tokens to more efficiently represent structured data. For example, compressed-format representation 138 may be characterized by a grammar that decreases a token sequence length of control sequences (e.g., value assignment operators, hierarchical structure boundaries, function calls, etc.) as generated by a given tokenizer.

Compressed-format representation 138 may provide a canonical representation of structured data generated by the model. For example, a canonical representation can provide a standard format for representing data independent from an original source format.

Compressed-format representation 138 can be particularly adapted for different types of structured data. For example, different intermediate structural representations may be used for different source data. For example, tabular data representations may be parsed into an intermediate representation adapted to represent tabular data in a token-efficient manner. Multi-modal datasets may be parsed into an intermediate representation adapted to represent multimodal data in a token-efficient manner. In general, compressed-format representations 138 may be adapted based on a token efficiency objective to increase a token efficiency of representing instances of an input domain of datatypes. A single canonical compressed-format representation 138 schema can be adapted to represent a broad domain of datatypes. More granularly adapted compressed-format representations 138 schemas may be adapted to represent more specific domains by evaluating the token efficiency objective in an optimization routine executed over the narrower domain.

Controller 108 can process compressed-format representation 138 using compression map 116 to invert the compression mapping to expand compressed-format representation 138 into the original structured data format or a different target structured data format. For example, controller 108 can apply a mapping between original values and reduced-token values to substitute the original values for the reduced-token values. Controller 108 can apply parser 110 to parse compressed-format representation 138 to detect one or more reduced-token values and substitute a corresponding original value defined by compression map 116.

Controller 108 can invoke one or more machine-learned models over multiple turns or iterations (e.g., N iterations) prior to preparing and outputting response 140. For example, controller 108 can implement a chain-of-thought self-deliberation technique to generate content describing reasoning about query 104. This generated content can be used to condition future generations of additional content in service of a final response 140. For example, a first input data structure can contain an instruction to generate a thorough analysis of query 104.

Output data structure 136 can contain the generated analysis. A second input data structure can contain the generated analysis along with an instruction to generate a final response based on the analysis. A second output data structure can contain the final response. Controller 108 can generate response 140 based on the second output data structure, which was based on the first output data structure. The raw outputs may not be surfaced to the user. For example, only a response 140 might be output to one or more output interface(s) 144. The intermediate outputs generated during the N iterations may be logged for analysis but may not be used in an output.

The intermediate outputs generated during the N iterations may be output to control one or more external tools or function calls. For example, in some implementations the intermediate outputs may be output for processing but not output for rendering for a user on a user interface.

Response 140 can include or be based on data from output data structure 136. Response 140 can be a final or complete response to query 104, or response 140 can be a partial response to query 104 that effectuates a step in a multi-step response (e.g., performing a subtask in a multi-part task).

Response 140 can include data for output to a user interface for rendering for a user. Response 140 can include text, image, audio, or other data that an output interface can render for a user.

Response 140 can include data for communication to a user (e.g., to a device associated with an account, to another agent, to an external system). Response 140 can include instructions to control a receiving system. For instance, response 140 can include an application programming interface call generated based on output data structure 136. For instance, one or more parameters of the application programming interface call can be generated by a machine-learned model and provided to controller 108 in output data structure 136. The application programming interface call can be parsed and packaged into response 140. Response 140 can be output via an output interface to a receiving system (e.g., over a network, over a system bus, via a software queue or operating system communication pathway) to initiate an action of the receiving system according to the application programming interface call.

Response 140 can be returned to a source system associated with query 104.

Response 140 can be passed to a different system to perform a task (e.g., an intermediate task, such as executing a function call in service of the original query; a final task, such as performing a task requested in query 104).

Response 140 may not contain structured data. For instance, structured data may only be present in an input query or one or more internal reasoning cycles of controller 108 and may not be passed in response 140. For example, a query 104 can include a question asked with respect to a provided structured data object. The answer to the question may not include structured data object(s) itself.

Response 140 can contain structured data 142 based on compressed-format representation 138. For example, machine-learned model system(s) 128 can generate predicted tokens that are detokenized into compressed-format representation 138. Controller 108 can process compressed-format representation 138 using compression map 116 to invert the compression mapping to expand compressed-format representation 138 into the original structured data format or a different target structured data format. For example, if the original structured data 106 was in JSON format, response 140 can contain structured data 142 that is also in JSON format, reconstructed from the compressed representation. For example, if the original structured data 106 was in YAML format, response 140 can contain structured data 142 that is in JSON format, reconstructed from the compressed representation. Other conversions or transformations may be used. For example, a response 140 output to perform an API call can structure the data according to an expected format of the API, which may be different from the original structured data 106 format.

Structured data 142 can be communicated in a message or data file or stream communicating response 140. Response 140 can include structured data 142.

Structured data 142 may be or include a representation of data organized in a structured format. A structured format can include a structured data representation language, such as JSON, XML, or YAML. A structured data representation language can be a language associated with a defined syntax having control sequences that control the interpretation of data or functional sequences. For example, one or more control sequences can provide a structure within which attribute names (e.g., “keys”) and attribute values (e.g., “values”) are defined. For instance, a control sequence between a first data sequence and a second data sequence (e.g., an equals sign between a variable and a numeral, a colon between a key and a value) can assign a value of one data sequence to be assigned with the other data sequence. Other example control sequences can include braces, brackets, tabs, commas, etc. An example structured data representation language includes a programming language that represents functional sequences (e.g., commands to be performed) and data sequences (e.g., variables) according to a defined syntax.

Structured data 142 can be associated with a parser (e.g., parser 110 or a different parser).

Structured data 142 may be embedded within response 140. It may be directly included as part of the response text. For example, a response string can contain a substring containing a textual structured data representation. Structured data 142 may be associated with response 140 as a separate data structure. For example, structured data 142 may be referenced by an identifier within response 140 text.

Output interfaces 144 can include various mechanisms and devices that enable controller 108 to communicate with users or other systems. These interfaces may consist of graphical user interfaces (GUIs), audio output devices, network connectivity devices, API libraries, and other components that can send data or render data relevant to the agent actions executed by the system. For example, GUIs can display responses to questions, results of a task, notifications about upcoming tasks, or alerts regarding any required user inputs. Audio outputs can provide auditory responses (e.g., spoken language responses) or alerts.

Output interface(s) 144 can include network interfaces that enable controller 108 to send data or commands to other systems. For instance, the output interfaces can facilitate the execution of API calls to external services.

In an example implementation, an input interface 102 and an output interface 144 can be associated with the same software application or device. For example, an application can provide an interface for interacting with a virtual assistant or other generative tool. The interactions can be implemented in one or multiple interaction modalities, such as a textual chat, a voice conversation, a situated agent (e.g., implemented using a wearable device). Inputs (e.g., query 104) can represent one part of a dialog corresponding to a user and responses 140 can represent the other part of the dialog corresponding to the agent's responses.

In an example practical scenario, a user may submit a query through a user interface on a user interface device. The user may be a human user interacting with a physical human machine interface or may be a computer system interacting via a network port or other communication interface. An example query is, “Find all products with the category ‘electronics’ and price less than $500.” This natural language query (e.g., query 104) can be received by the input interface 102 of the software application.

A product information table may contain data in JSON format. For instance, a product entry might include ′{“generic_name”: “Laptop”, “ product_category”: “electronics”, “msrp”: 1200}′. This structured data 106 may be associated with query 104 (e.g., contained in query, referenced by query 104, retrieved in response to query 104, etc.).

In one example, a local user computing system executes a software application that sends structured data 106 and query 104 to a remote server. The remote server implements the controller 108. The same or a different server system can implement machine-learned model system(s) 128.

In another example, a local user computing system executes a software application that sends structured data 106 and query 104 to a local controller 108 operating on the local user computing system. The same or a different computing system can implement machine-learned model system(s) 128. For example, controller 108 may operate locally while a different (e.g., more powerful) system may operate machine-learned model system(s) 128.

The controller 108 receives the structured data 106 and the query 104. Parser 110 processes the structured data 106 to extract the relevant information and transforms it into a parsed structured data 112 format. Encoder 114 accesses a compression map 116 to transform the parsed structured data 112 into a compressed-format representation 124. The compression map 116 contains mappings between the elements of the parsed structured data 112 and corresponding sequences in the compressed-format representation 124. The encoder 114 generates the compressed-format representation 124.

For example, long keys like “generic_name,” “product_category,” and “msrp” may be repeated a number of times in the structured data. These names might be tokenized into more than one token (e.g., two or more tokens). Encoder 114 can replace these longer names with a shorter name that may be tokenized in fewer tokens (e.g., only one token). For example, long keys like “generic_name,” “product_category,” and “msrp” may be replaced with more token-efficient sequences like “name”, “category”, and “price,” which may be each representable with a single token. Compression map 116 can generate a mapping between the original key names and the new, shorter substitutions.

In some implementations, to reduce a token count associated with a control sequence that assigns values (e.g., “:” or “=” between keys and values), compressed-format representation 124 may be structured so that assignment is implicit. For example, boundary tokens may be applied to mark the beginning and end of a sequence of tokens representing a value. The value can be implicitly understood to be assigned to a key formed from the tokens preceding opening boundary token. For example, the example object could be represented as ′{name“Laptop”category“electronics”price<1200>}′. In an example, different boundary tokens can be used to signal different datatypes (e.g., integer vs string). Nested hierarchies can be compressed in like manner. For instance, ‘{key[element, {key‘value’}]}’. Other implicit rules may be used to compress further. For example, it may be defined that keys do not contain numerals, such that a sequence ‘x1’ could be understood as “x”: 1. It may be defined that single-entry lists (e.g., [el]) or dictionaries (e.g., {key: value}) may omit a closing boundary. It may be defined that special values (e.g., Booleans, type flags for format type such as ‘json’, etc.) are not present in key names, such that the detection of such a value signals the beginning of a value. For instance, availableTrue may be a two-token compressed representation of ‘“available”: True’, which could consume 3, 4, or more tokens.

Some tokenizers may already contain some tokens that represent control sequences that are commonly used in structured data representations (e.g., <=′>and <′}, >). When using such expressive tokenizers, some additional textual characters can be maintained in the compressed-format representation, as the additional context represented in the dedicated token embeddings for that control sequence may be leveraged without increasing a token count.

For example, ′{“generic_name”: “Laptop”, “product_category”: “electronics”, “msrp”: 1200}′ may be represented as ′{name=“Laptop”, category=“electronics”, price=1200}′ which may be tokenized by one tokenizer as a list of tokens [{name>, <=″>, <Laptop>, <″, >, <category>, <=″>, <electronics>, <″, >, <price>, <=>, <120>, <0>, <>]. Another tokenizer may tokenize into a different list of tokens: [{>, <name>, <=″>, <Laptop>, <″, >, <category>, <=″>, <electronics>, <″, >, <price>, <=>, <1>, <2>, <0>, <0>, <}>].

The resulting compressed-format representation 124 may then be passed to the machine-learned model systems 128 in an input data structure 122. Machine-learned model systems 128 receive the input data structure 122, which contains the compressed-format representation 124. The input data structure 122 is processed by tokenizers 130 to generate a token sequence representing compressed-format representation 124. A token can be a designated value that represents a portion of an input (e.g., a substring, a patch of an image, an interval of audio, etc.). Each token can have a token identifier. Each token can be associated with a token embedding.

Prediction layers 132 may then receive the tokenized representation. The prediction layers 132 may process the tokenized representation (e.g., an input tensor of token embeddings) to generate a prediction output. The prediction output can be a sequence of one or more predicted tokens. The prediction output may be passed to detokenizers 134.

Detokenizers 134 receive the prediction output. Detokenizers 134 process the prediction output to generate an output data structure 136. The output data structure 136 contains a response generated based on predictions from the model, which may include a compressed-format representation 138 of structured data. Detokenizer 134 can map token IDs to a corresponding chunk or token of data (e.g., a substring) and concatenate the chunks.

Controller 108 can receive output data structure 136 from machine-learned model systems 128 and process output data structure 136 to generate a query response 140 based on output data structure 136. If output data structure 136 contains a compressed-format representation 138, controller 108 can use compression map 116 to expand (e.g., using a reverse mapping) compressed-format representation 138 into structured data 142. Structured data 142 can be, for instance, a JSON object containing the information requested by the user. Controller 108 can output response 140 via an output interface 144.

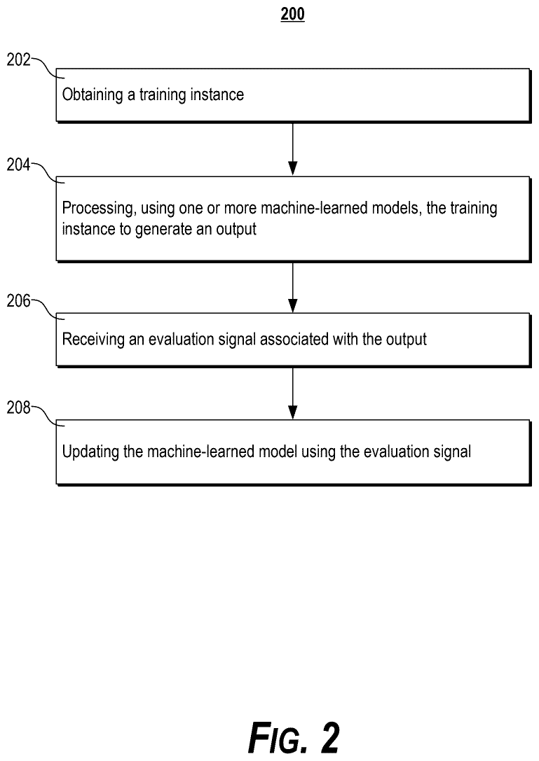

FIG. 2 depicts a flowchart of a method 200 for training one or more machine-learned models or other learnable components (e.g., compression map 116, encoder 114) according to aspects of the present disclosure. For instance, an example machine-learned model can include any one or more models implemented on machine-learned sequence processing system 128.

One or more portion(s) of example method 200 can be implemented by a computing system that includes one or more computing devices such as, for example, computing systems described with reference to the other figures. Each respective portion of example method 200 can be performed by any (or any combination) of one or more computing devices.

Moreover, one or more portion(s) of example method 200 can be implemented on the hardware components of the device(s) described herein, for example, to train one or more systems or models. FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for exemplary illustrated purposes and is not meant to be limiting. One or more portions of example method 200 can be performed additionally, or alternatively, by other systems.

At 202, example method 200 can include obtaining a training instance. A set of training data can include a plurality of training instances divided between multiple datasets (e.g., a training dataset, a validation dataset, or testing dataset). A training instance can be labeled or unlabeled. Although referred to in example method 200 as a “training” instance, it is to be understood that runtime inferences can form training instances when a model is trained using an evaluation of the model's performance on that runtime instance (e.g., online training/learning).

Example data types for the training instance and various tasks associated therewith are described throughout the present disclosure.

At 204, example method 200 can include processing, using one or more machine-learned models, the training instance to generate an output. The output can be directly obtained from the one or more machine-learned models or can be a downstream result of a chain of processing operations that includes an output of the one or more machine-learned models.

At 206, example method 200 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 208, example method 200 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 200 can include implementing a number of generalization techniques (e.g., weight decays, dropouts, etc.) to improve the generalization capability of the models being trained.

In some implementations, example method 200 can be implemented for training a machine-learned model from an initialized state to a fully trained state (e.g., when the model exhibits a desired performance profile, such as based on accuracy, precision, recall, etc.).

In some implementations, example method 200 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types.

In some implementations, example method 200 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 200 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 200 can be implemented to execute parameter-efficient fine-tuning methods, such as by learning small adjustments to original parameters that can be overlaid to “adapt” the base model. An example method is Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on feedback on model performance during use. The feedback can be provided by users or other systems that can score or otherwise evaluate the model and provide a signal that communicates the evaluation.

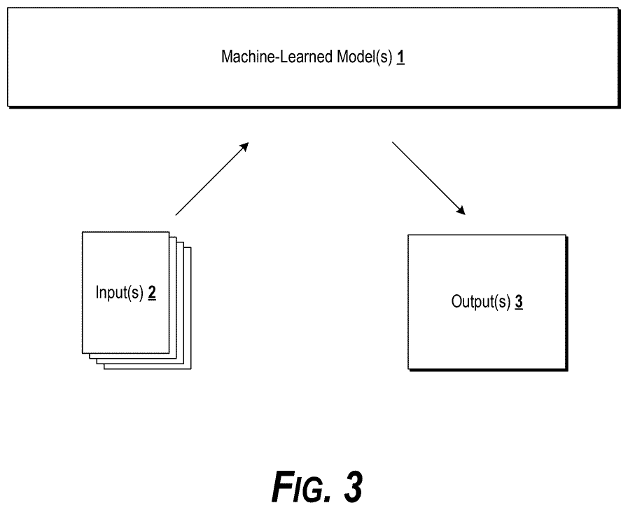

FIG. 3 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more models of machine-learned model system 128 used for any operation of any component of a system such as an agent system, an assistant system, etc. Although various features, variations, and implementations described below are described with respect to machine-learned model(s) 1, it is to be understood that such features, variations, and implementations are to be understood as described with respect to each of any one or more models of machine-learned model system 128 used for any operation of any component of a system such as an agent system, an assistant system, etc., or any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

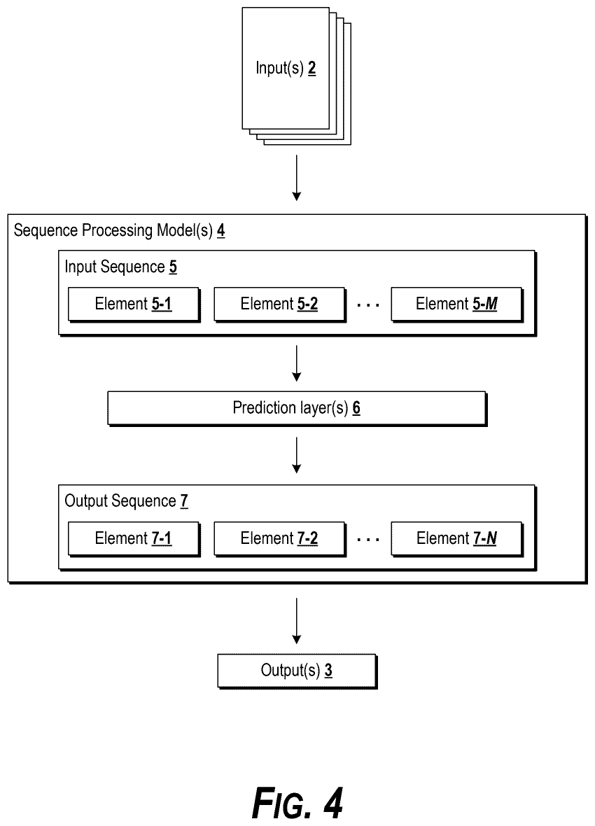

FIG. 4 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 4 can be the tokens or can be the embedded representations thereof.

Prediction layer(s) 6 can predict one or more output elements 7-1, 7-2,. 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.” A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

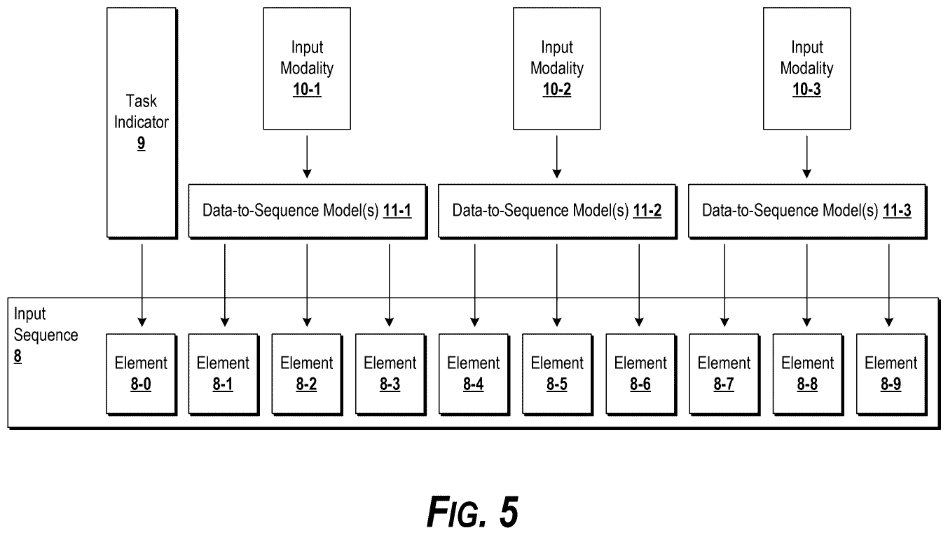

FIG. 5 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space.

For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4.

Data-to-sequence models 11-1, 11-2, and 11-3 can be trained end-to-end with machine-learned sequence processing model(s) 4.

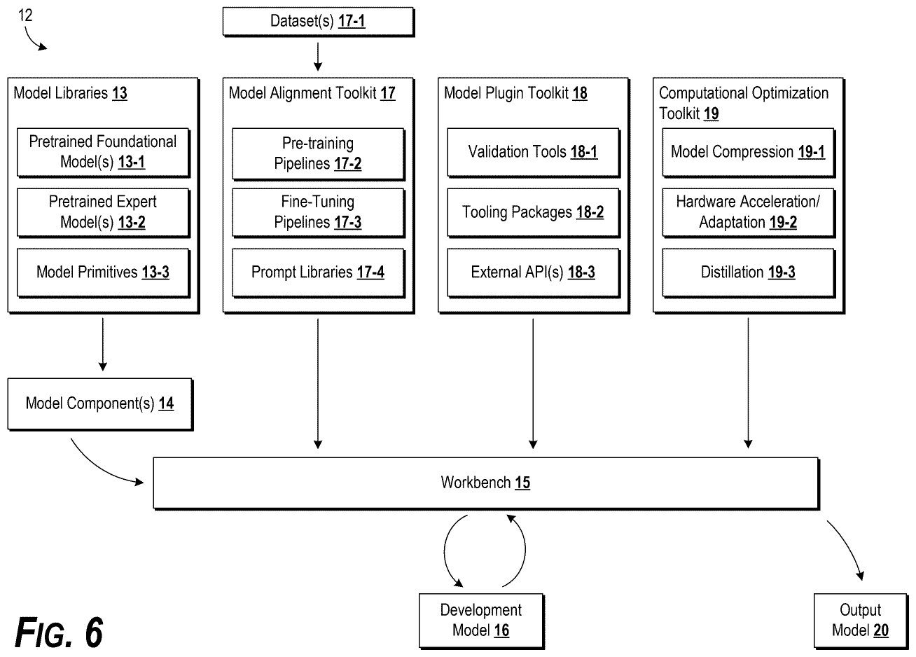

FIG. 6 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models-e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

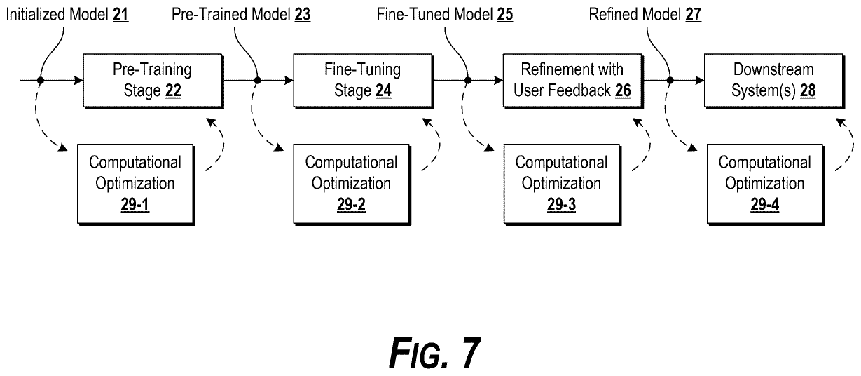

FIG. 7 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

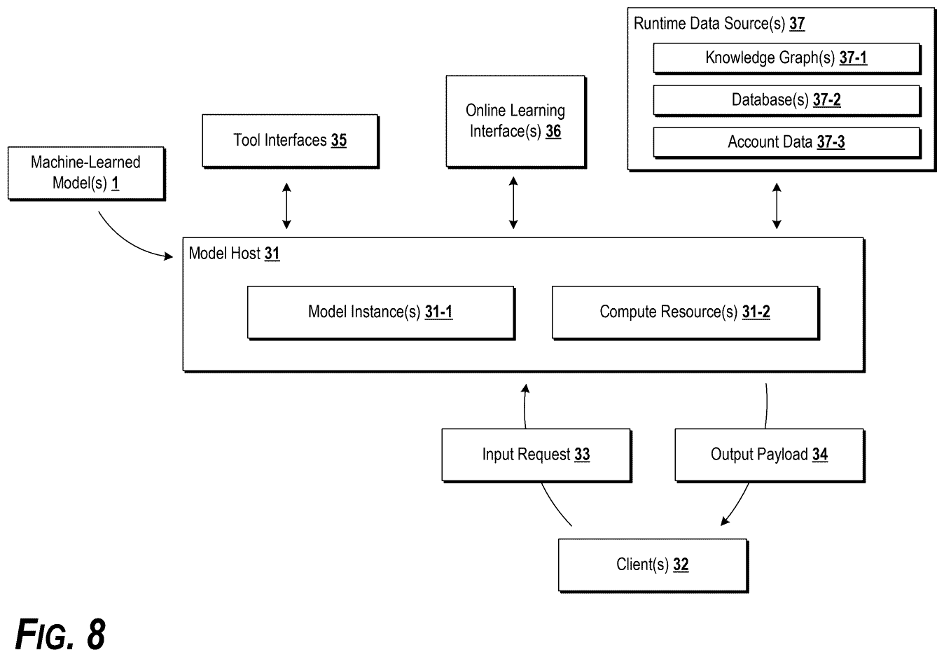

FIG. 8 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

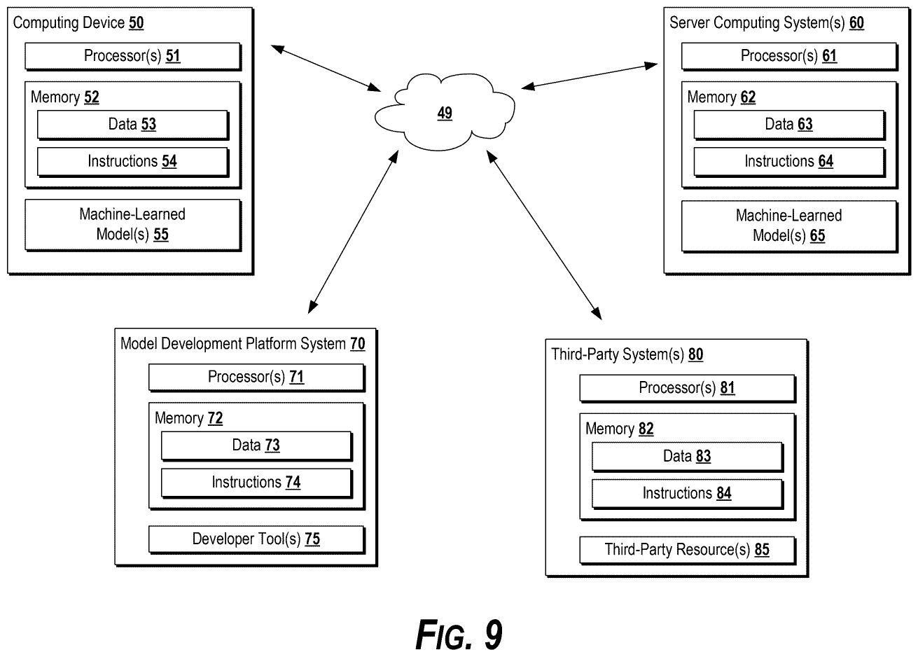

FIG. 9 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 9 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

In some implementations, computing device 50 and server computing system(s) 60 can implement one or more aspects of a system for processing compressed-format representations in accordance with example embodiments of the present disclosure. For instance, a computing device 50 can generate a compressed-format representation of data (e.g., generate compressed-format representation of input(s) 2) and input the compressed-format representation to a machine-learned model. The machine-learned model can be hosted on computing device 50 or on a remote system, such as server computing system(s) 60. In some implementations, communications transmitted between computing device 50 and server computing system(s) 60 can be transacted based on the compressed-format representation of the data. In this manner, for instance, a communication cost between the systems may be decreased relative to an instance in which the computing device 50 transmits the entire (uncompressed) representation.

FIG. 9 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

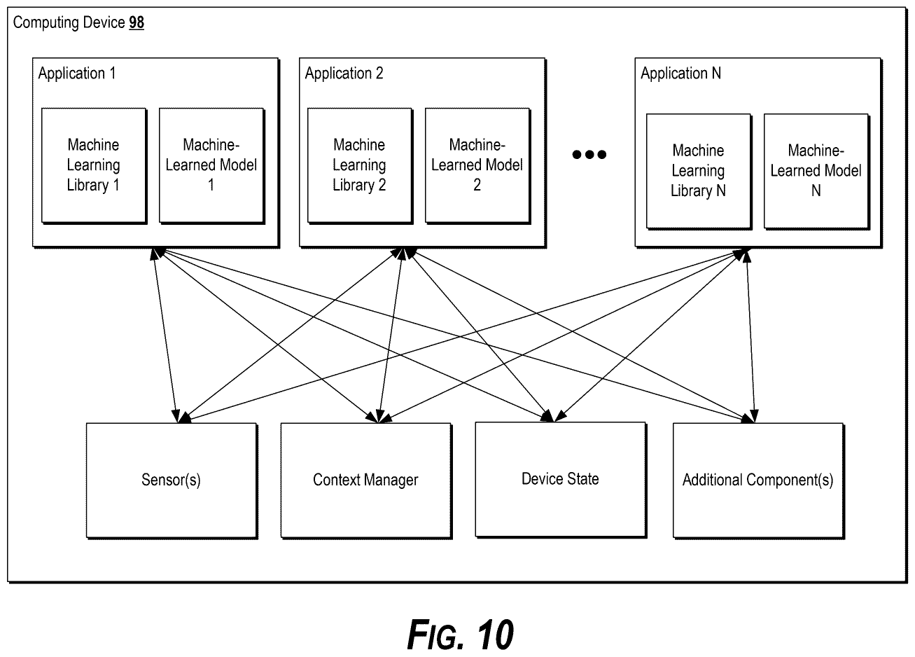

FIG. 10 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 10, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

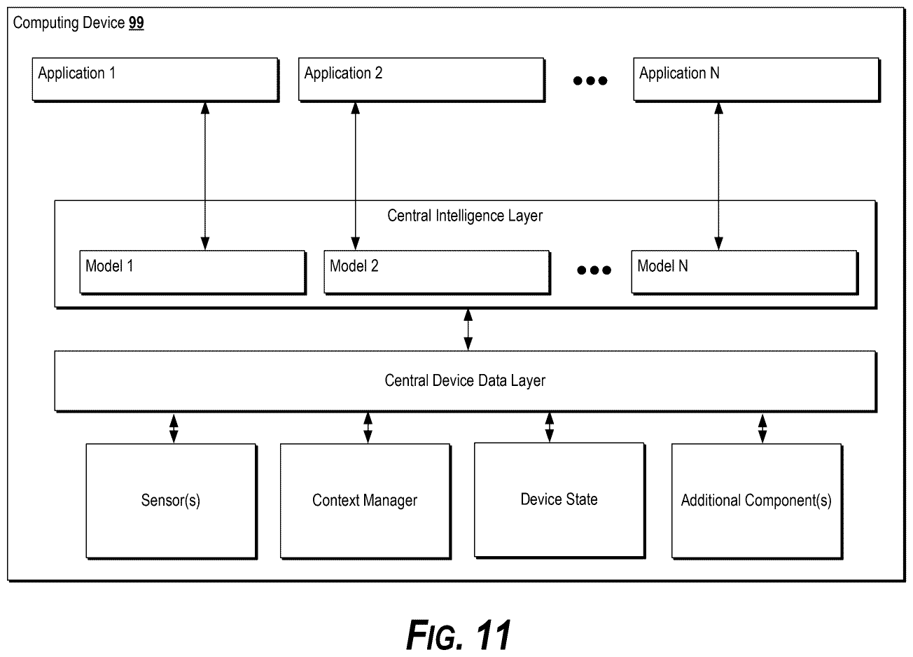

FIG. 11 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

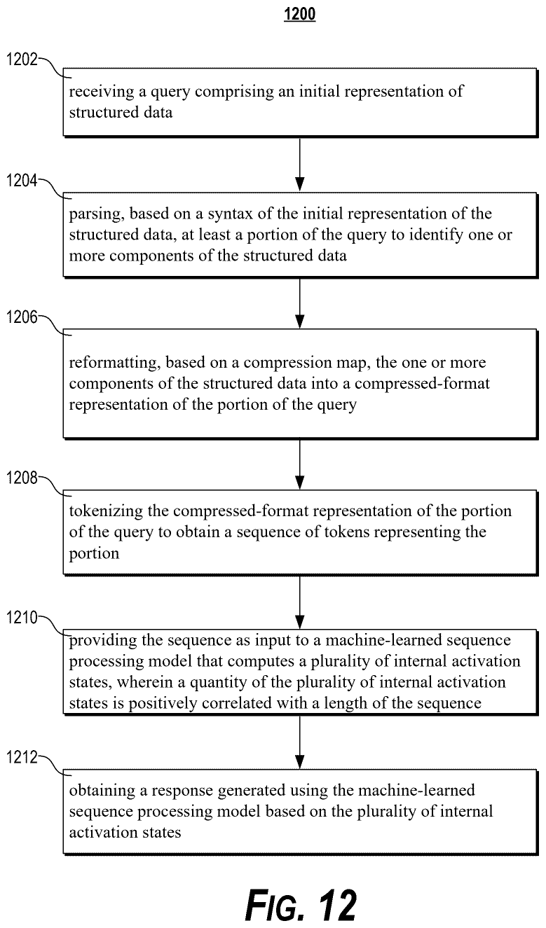

FIG. 12 depicts a flowchart of a method 1200 for implementing a machine-learned sequence processing model to process a compressed-format representation according to aspects of the present disclosure.

One or more portion(s) of example method 1200 can be implemented by a computing system that includes one or more computing devices such as, for example, computing systems described with reference to the other figures. Each respective portion of example method 1200 can be performed by any (or any combination) of one or more computing devices. Moreover, one or more portion(s) of example method 1200 can be implemented on the hardware components of the device(s) described herein, for example, to train one or more systems or models.

FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of example method 1200 can be performed additionally, or alternatively, by other systems.

At 1202, example method 1200 includes receiving a query comprising an initial representation of structured data. For example, a query 104 can be received by a computing system via input interface(s) 102. Query 104 can include various different data. Query 104 can include structured data (e.g., structured data 106). Query 104 may not include structured data. Controller 108 can receive query 104.

At 1204, example method 1200 includes parsing, based on a syntax of the initial representation of the structured data, at least a portion of the query to identify one or more components of the structured data. For example, controller 108 can parse query 104, or a portion thereof, to detect structured data 106 and interpret the data communicated in structured data 106. For example, structured data 106 can be represented in a structured computer language that can be parsed to construct an in-memory representation of a structured data object. For example, parsing structured data 106 can include detecting control sequences (e.g., assignment operators, mathematical operators, or other control characters) and storing or representing data in accordance with the control sequences. For example, parsing can include detecting key: value pairs, in which a control sequence may include a colon. A component of the structured data may include a key-value pair, a command, a function call, a variable name, or any other attribute representing within the syntactical framework of structured data 106. Controller 108 can, for instance, extract parsed structured data 112 based on parsing, with parser 110, a portion of structured data 106.

At 1206, example method 1200 includes reformatting, based on a compression map, the one or more components of the structured data into a compressed-format representation of the portion of the query. For example, controller 108 can use an encoder 114 to reformat parsed structured data 112 according to one or more rule or features of compression map 116.

For example, compression map 116 can store or describe relationships between a compressed-format representation of a data item and an original expanded-format representation of the data item. For instance, compression map 116 can describe transformations between an uncompressed representational space and a compressed representational space.

At 1208, example method 1200 includes tokenizing the compressed-format representation of the portion of the query to obtain a sequence of tokens representing the portion. For example, a compressed-format representation of the portion of the query can include a string representation of the portion of the query. The string representation can include control sequences that are more token-efficient methods for designating the same control effect on a data structure (e.g., assignment, nesting, boundary, etc.). Token efficiency can include a number of tokens used to represent a fixed quantum of data.

At 1210, example method 1200 includes providing the sequence as input to a machine-learned sequence processing model that computes a plurality of internal activation states, wherein a quantity of the plurality of internal activation states is positively correlated with a length of the sequence. For example, a machine-learned sequence processing model can implement an attention operation to evaluate a particular token in the context of one or more corresponding tokens. For example, a self-attention operation can involve computing a relatedness factor (e.g., attention score) between a particular token and one or more other tokens in the same sequence. In some implementations, this can cause a quadratic scaling effect for memory and compute consumption.

At 1212, example method 1200 includes obtaining a response generated using the machine-learned sequence processing model based on the plurality of internal activation states. For example, a machine-learned sequence processing model output can include tokens that are generated with a probability predicted by the machine-learned sequence processing model. For example, a system can receive the response from a server system that hosts the model to execute inference on behalf of the system.

In some implementations of example method 1200, the compression map is configured to reduce a number of tokens in the sequence of tokens representing the portion. For example, the compression map can be configured to reduce an expected value of a quantity of tokens for a given input. The configuration can occur by definition (e.g., assigning more compact control sequences to operations, such as data structure delimiters or assignment operators) or via training (e.g., a search algorithm to evaluate different expressions).

In some implementations of example method 1200, reformatting, based on the compression map, the one or more components of the structured data into the compressed-format representation of the portion of the query includes determining, based on the compression map, a control sequence for representing at least one of the one or more components in the compressed-format representation. For example, a control sequence can include an assignment operator, an application number, or other syntactical elements.

In some implementations of example method 1200, the compressed-format representation of the portion of the query includes a textual representation. For example, a JSON string can be parsed to extract keys and values and lists represented in the JSON object.

In some implementations, example method 1200 includes generating a compressed-format representation of at least a portion of the response. For example, a response can include a portion of structured data. In generation of the response, a model can output tokens that correspond to control sequences and value sequences that align with the defined syntax of the compressed-format representation.

In some implementations, example method 1200 includes parsing, based on a syntax of the compressed-format representation of at least the portion of the response, the compressed-format representation of the one or more outputs to identify one or more components of at least the portion of the response. For example, a parser can traverse the compressed-format representation to identify patterns and structures within the compressed-format representation that conform to a defined syntax of the compressed-format representation. The parser can detect one or more control sequences that correspond to a defined component of the compressed-format representation (e.g., a defined value, a defined attribute, a key name, a defined operator, a defined function, etc.).

In some implementations, example method 1200 includes reformatting, based on the compression map, the one or more components of at least the portion of the response into an expanded-format representation of the one or more components of at least the portion of the response. For example, an identified component can be reformatted by mapping one or more control sequences (e.g., assignment operators, delimiter expressions, etc.) of the compressed-format representation to one or more corresponding control sequences of an expanded-format representation (e.g., JSON, YAML, etc.) that has not been compressed by encoder 114. For example, an identified component can be reformatted by mapping one or more values (e.g., an ad-hoc shortened value, etc.) of the compressed-format representation to one or more corresponding values of an expanded-format representation (e.g., an original value mapped to the ad-hoc value, etc.).

In some implementations, example method 1200 includes replacing an original value in at least the portion of the response with an ad-hoc value to represent the original value in the compressed-format representation of at least the portion of the response. For example, long repeated key names can be replaced with shorter names that, when tokenized, consume fewer tokens of input.

In some implementations, example method 1200 includes initializing an embedding vector associated with a token representing the ad-hoc value based on one or more embedding vectors associated with one or more tokens representing the original value.

In some implementations, example method 1200 includes providing, as input to the machine-learned sequence processing model, a mapping of original values to ad-hoc values. In some implementations of example method 1200, the machine-learned sequence processing model attends over the mapping of original values to ad-hoc values to associate the original values and the ad-hoc values.

In some implementations of example method 1200, generating the compressed-format representation of at least the portion of the response includes detokenizing the response to generate the compressed-format representation of at least the portion of the response. For example, a detokenizer can operate to combine tokens output by the machine-learned sequence process model into a representation that, when combined, forms the compressed-format representation (e.g., a string of text).

In some implementations of example method 1200, the initial representation of the structured data represents the data in a first structured data language. In some implementations of example method 1200, the expanded-format representation of the one or more outputs represents the one or more outputs in the first structured data language. For example, if the query contains JSON then controller 108 can cause the response to render structured data in JSON.

In some implementations of example method 1200, the initial representation of the structured data represents the data in a first structured data language. In some implementations of example method 1200, the expanded-format representation of the one or more outputs represents the one or more outputs in a second structured data language. For example, the query may contain JSON for a first data item and controller 108 can cause the response to render structured data in a different format (e.g., YAML). The data rendered in the different format can be the same or different data (e.g. to perform a conversion task on the same data; to generate different data in different formats, etc.).

In some implementations of example method 1200, the expanded-format representation of the one or more outputs is configured based on an identifier associated with the query. In some implementations of example method 1200, the identifier is associated with one or more preferences, and the expanded-format representation is generated based on the one or more preferences. The identifier can be, for example, a user account identifier, an API key or other credential, an input parameter to the API, etc. For example, a profile may be associated with one or more preferences associated with operation of the system (e.g., preferences for the format in which data is to be communicated, such as for communication to a user interface or a downstream API or other system). Based on a profile corresponding to the identifier, the expanded-format representation can be constructed or adapted to conform to one or more preference configurations. For instance, a particular output format can be selected, particular modifications can be applied (e.g., the indentation, spacing, language, etc.).

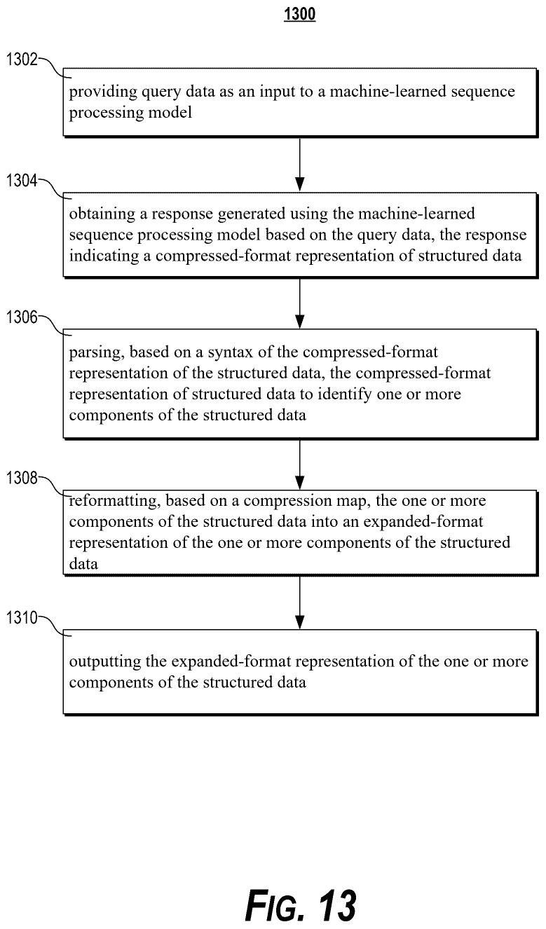

FIG. 13 depicts a flowchart of a method 1300 for implementing a machine-learned sequence processing model to process a compressed-format representation according to aspects of the present disclosure.

One or more portion(s) of example method 1300 can be implemented by a computing system that includes one or more computing devices such as, for example, computing systems described with reference to the other figures. Each respective portion of example method 1300 can be performed by any (or any combination) of one or more computing devices. Moreover, one or more portion(s) of example method 1300 can be implemented on the hardware components of the device(s) described herein, for example, to train one or more systems or models.

FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of example method 1300 can be performed additionally, or alternatively, by other systems.

At 1302, example method 1300 includes providing query data as an input to a machine-learned sequence processing model. For example, an input to the machine-learned sequence processing model can contain data provided to condition a generation of additional data, querying the model for a response. The query data may be obtained from or based on a query received by controller 108.

At 1304, example method 1300 includes obtaining a response generated using the machine-learned sequence processing model based on the query data, the response indicating a compressed-format representation of structured data. For example, outputs of the machine-learned processing model can include tokens that, when combined, form a representation of data that conforms to a defined syntax of the compressed-format representation (e.g., according to the compression map 116).

At 1306, example method 1300 includes parsing, based on a syntax of the compressed-format representation of the structured data, the compressed-format representation of structured data to identify one or more components of the structured data. For example, a parser can traverse the compressed-format representation to identify patterns and structures within the compressed-format representation that conform to the defined syntax of the compressed-format representation. The parser can detect one or more control sequences that correspond to a defined component of the compressed-format representation (e.g., a defined value, a defined attribute, a key name, a defined operator, a defined function, etc.).

At 1308, example method 1300 includes reformatting, based on a compression map, the one or more components of the structured data into an expanded-format representation of the one or more components of the structured data. For example, controller 108 can use an encoder 114 to reformat the parsed data according to one or more rule or features of compression map 116. For example, compression map 116 can store or describe relationships between a compressed-format representation of a data item and an expanded-format representation of the data item. For instance, compression map 116 can describe transformations between an uncompressed representational space and a compressed representational space.

At 1310, example method 1300 includes outputting the expanded-format representation of the one or more components of the structured data. For example, outputting can include outputting via an output interface 144.

In some implementations, example method 1300 includes detokenizing the response to generate the compressed-format representation of at least the portion of the response.

In some implementations of example method 1300, the response is generated using the machine-learned sequence processing model based on computing, based on a first portion of the response, a plurality of internal activation states, wherein a quantity of the plurality of internal activation states corresponds to a length of the first portion of the response. In some implementations of example method 1300, the response is generated using the machine-learned sequence processing model based on generating, by the machine-learned sequence processing model, and based on the plurality of internal activation states, a second portion of the response.

In some implementations of example method 1300, obtaining the response includes autoregressively generating, by the machine-learned sequence processing model, one or more tokens of the response, wherein for each of the one or more tokens of the response, the machine-learned sequence processing model computes a plurality of attention values with respect to one or more other tokens of the response that correspond to the compressed-format representation of at least the portion of the response. For example, the predictions of the model can be based in one or more autoregressive iterations on a tokenized representation of the compressed-format representation.

In some implementations, example method 1300 includes receiving a query comprising an initial representation of structured data.

In some implementations, example method 1300 includes parsing, based on a syntax of the initial representation of the structured data, at least a portion of the query to identify one or more components of the structured data.

In some implementations, example method 1300 includes reformatting, based on the compression map, the one or more components of the structured data into a compressed-format representation of the portion of the query.

In some implementations, example method 1300 includes tokenizing the compressed-format representation of the portion of the query to obtain a sequence of tokens representing the portion.

In some implementations, example method 1300 includes providing the sequence as the input to the machine-learned sequence processing model.

In some implementations of example method 1300, generating the compressed-format representation of at least the portion of the response includes detokenizing one or more outputs of the machine-learned sequence processing model to generate the compressed-format representation of the structured data.

In some implementations of example method 1300, reformatting, based on the compression map, the one or more components of the structured data into the compressed-format representation of the portion of the query includes determining, based on the compression map, a control sequence for representing at least one of the one or more components in the compressed-format representation.

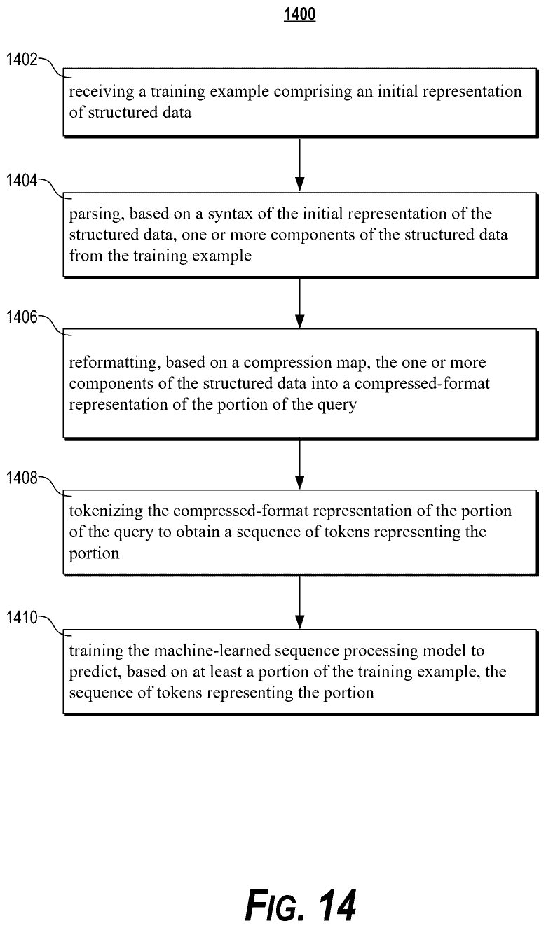

FIG. 14 depicts a flowchart of a method 1400 for training a machine-learned sequence processing model to process a compressed-format representation according to aspects of the present disclosure.

One or more portion(s) of example method 1400 can be implemented by a computing system that includes one or more computing devices such as, for example, computing systems described with reference to the other figures. Each respective portion of example method 1400 can be performed by any (or any combination) of one or more computing devices.

Moreover, one or more portion(s) of example method 1400 can be implemented on the hardware components of the device(s) described herein, for example, to train one or more systems or models.

FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of example method 1400 can be performed additionally, or alternatively, by other systems.

At 1402, example method 1400 includes receiving a training example comprising an initial representation of structured data.

At 1404, example method 1400 includes parsing, based on a syntax of the initial representation of the structured data, one or more components of the structured data from the training example.

At 1406, example method 1400 includes reformatting, based on a compression map, the one or more components of the structured data into a compressed-format representation of the portion of the query.

At 1408, example method 1400 includes tokenizing the compressed-format representation of the portion of the query to obtain a sequence of tokens representing the portion.

At 1410, example method 1400 includes training the machine-learned sequence processing model to predict, based on at least a portion of the training example, the sequence of tokens representing the portion. For example, a language modeling loss can be applied over the sequence of tokens to determine a loss. The loss can be used for updating the parameters of the model. An example training method can include method 200.

In some implementations, example method 1400 includes one or more implementations of example method 1200 or example method 1300. For instance, during training, inputs may be provided to a model and outputs may be obtained from the model for evaluation.

In some implementations of example method 1400, during training the machine-learned sequence processing model is provided inputs that contain a compressed-format representation and a second representation that is not the compressed-format representation (e.g., that has not been compressed by encoder 114). For instance, the compressed-format representation can be accompanied by plain text, image data, audio, or any other data modality. For instance, the compressed-format representation can be accompanied by plain text, image data, audio, or any other data modality.

For example, tokens corresponding to a compressed-format representation of structured data may be interleaved with tokens corresponding to other data in an input sequence to a model. This input sequence can result from a partial mapping of an original training example. For example, a training example can contain structured data and non-structured data.

The structured data can be compressed by the encoder 114 into the compressed-format representation. The compressed-format representation of the structured data can be tokenized for input to the model. The non-structured data may be tokenized directly (e.g., tokenized without transformation by encoder 114).

In some implementations, encoder 114 may be trained at 1410 (in lieu of or in addition to the machine-learned sequence processing model). For example, a loss can penalize a token length or compression ratio of the compressed format representation so that a training system can cause encoder 114 to update to implement more compact representations by updating compression map 116.

In some implementations, encoder 114 can be trained using an evolutionary algorithm, reinforcement learning, or another search algorithm. For instance, a neural architecture search technique may be applied to learn one or more configuration parameters of compression map 116.

In some implementations, encoder 114 can be trained or optimized without a machine-learned sequence processing model in the loop. For example, a cost of mapping an expanded-format representation to a compressed-format representation can be computed without performing inference using a machine-learned sequence processing model.

In some implementations, encoder 114 can be trained or optimized with a tokenizer associated with a machine-learned sequence processing model in the loop. For example, a cost of mapping an expanded-format representation to a compressed-format representation can be computed by tokenizing candidate compressed-format representations using a designated tokenizer. Different compression maps can be learned for different tokenizers.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method comprising:
receiving a query comprising an initial representation of structured data;
parsing, based on a syntax of the initial representation of the structured data, at least a portion of the query to identify one or more components of the structured data;
reformatting, based on a compression map, the one or more components of the structured data into a compressed-format representation of the portion of the query;
tokenizing the compressed-format representation of the portion of the query to obtain a sequence of tokens representing the portion;
providing the sequence as input to a machine-learned sequence processing model that computes a plurality of internal activation states descriptive of associations between the tokens in the sequence, wherein a quantity of the plurality of internal activation states is positively correlated with a length of the sequence; and
obtaining a response generated using the machine-learned sequence processing model based on the plurality of internal activation states.

2. The computer-implemented method of claim 1, wherein the compression map is configured to reduce a number of tokens in the sequence of tokens representing the portion.

3. The computer-implemented method of claim 1, wherein reformatting, based on the compression map, the one or more components of the structured data into the compressed-format representation of the portion of the query comprises:
determining, based on the compression map, a control sequence for representing at least one of the one or more components in the compressed-format representation.

4. The computer-implemented method of claim 1, wherein the compressed-format representation of the portion of the query comprises a textual representation.

5. The computer-implemented method of claim 1, comprising:
generating a compressed-format representation of at least a portion of the response;
parsing, based on a syntax of the compressed-format representation of at least the portion of the response, the compressed-format representation of at least the portion of the response to identify one or more components of at least the portion of the response; and
reformatting, based on the compression map, the one or more components of at least the portion of the response into an expanded-format representation of the one or more components of at least the portion of the response.

6. The computer-implemented method of claim 5, wherein generating the compressed-format representation of at least the portion of the response comprises:
detokenizing the response to generate the compressed-format representation of at least the portion of the response.

7. The computer-implemented method of claim 1, comprising:
replacing an original value in at least the portion of the response with an ad-hoc value to represent the original value in the compressed-format representation of at least the portion of the response.

8. The computer-implemented method of claim 7, comprising:
initializing an embedding vector associated with a token representing the ad-hoc value based on one or more embedding vectors associated with one or more tokens representing the original value.

9. The computer-implemented method of claim 5, wherein:
the initial representation of the structured data represents the data in a first structured data language;
the expanded-format representation of at least the portion of the response represents at least the portion of the response in the first structured data language.

10. The computer-implemented method of claim 5, wherein:
the initial representation of the structured data represents the data in a first structured data language;
the expanded-format representation of at least the portion of the response represents at least the portion of the response in a second structured data language.

11. The computer-implemented method of claim 5, wherein the expanded-format representation of at least the portion of the response is configured based on an identifier associated with the query.

12. The computer-implemented method of claim 11, wherein the identifier is associated with one or more preferences, and wherein the expanded-format representation is generated based on the one or more preferences.

13. A computer-implemented method, comprising:
providing query data as an input to a machine-learned sequence processing model;
obtaining a response generated using the machine-learned sequence processing model based on the query data, the response indicating a compressed-format representation of at least a portion of the response, wherein the machine-learned sequence processing model computes a plurality of internal activation states descriptive of associations between tokens in a sequence of tokens representing the compressed-format representation;
parsing, based on a syntax of the compressed-format representation of at least the portion of the response, the compressed-format representation of structured data to identify one or more components of the structured data;
reformatting, based on a compression map, the one or more components of the structured data into an expanded-format representation of the one or more components of the structured data; and
outputting the expanded-format representation of the one or more components of the structured data.

14. The computer-implemented method of claim 13, comprising:
detokenizing the response to generate the compressed-format representation of at least the portion of the response.

15. The computer-implemented method of claim 13, the response generated using the machine-learned sequence processing model based on:
computing, based on a first portion of the response, a plurality of internal activation states, wherein a quantity of the plurality of internal activation states corresponds to a length of the first portion of the response; and
generating, by the machine-learned sequence processing model, and based on the plurality of internal activation states, a second portion of the response.

16. The computer-implemented method of claim 13, wherein obtaining the response comprises:
autoregressively generating, by the machine-learned sequence processing model, one or more tokens of the response, wherein for each of the one or more tokens of the response, the machine-learned sequence processing model computes a plurality of attention values with respect to one or more other tokens of the response that correspond to the compressed-format representation of at least the portion of the response.

17. The computer-implemented method of claim 13, comprising:
receiving a query comprising an initial representation of structured data;
parsing, based on a syntax of the initial representation of the structured data, at least a portion of the query to identify one or more components of the structured data;
reformatting, based on the compression map, the one or more components of the structured data into a compressed-format representation of the portion of the query;
tokenizing the compressed-format representation of the portion of the query to obtain a sequence of tokens representing the portion; and
providing the sequence as the input to the machine-learned sequence processing model.

18. The computer-implemented method of claim 17, wherein generating the compressed-format representation of at least the portion of the response comprises:
detokenizing one or more outputs of the machine-learned sequence processing model to generate the compressed-format representation of the structured data.

19. The computer-implemented method of claim 13, wherein reformatting, based on the compression map, the one or more components of the structured data into the compressed-format representation of the portion of the query comprises:
determining, based on the compression map, a control sequence for representing at least one of the one or more components in the compressed-format representation.

20. A computer-implemented method comprising:
receiving a training example comprising an initial representation of structured data;
parsing, based on a syntax of the initial representation of the structured data, one or more components of the structured data from the training example;
reformatting, based on a compression map, the one or more components of the structured data into a compressed-format representation of the one or more components of the structured data;
tokenizing the compressed-format representation of the one or more components of the structured data to obtain a sequence of tokens representing the one or more components of the structured data; and
training a machine-learned sequence processing model to predict, based on at least a portion of the training example, the sequence of tokens representing the one or more components of the structured data.
